(19) United States
(12) Patent Application Publication
(10) Pub. No.: US 2026/0234416 A1
(43) Pub. Date: Aug. 13, 2026

(54) COMPOSITION, SURFACE TREATMENT AGENT, ARTICLE, AND METHOD OF PRODUCING ARTICLE

(71) Applicant: AGC Inc., Tokyo (JP)

(72) Inventors: Shiori KAWAKAMI, Tokyo (JP); Hironobu SAKAGUCHI, Tokyo (JP)

(73) Assignee: AGC Inc., Tokyo (JP)

(21) Appl. No.: 19/638,234

(22) Filed: Apr. 3, 2026

Related U.S. Application Data
(63) Continuation of application No. PCT/JP2024/035854, filed on Oct. 7, 2024.

(30) Foreign Application Priority Data
Oct. 6, 2023 (JP) 2023-174756

(51) Int. Cl. C09D 5/16; C08G 77/54; C09D 183/14

(52) U.S. Cl. CPC C09D 5/1675; C08G 77/54; C09D 183/14

(57) ABSTRACT

A composition contains a first compound and a second compound, in which the first compound and the second compound are each represented by Formula (A), and at least one of T or Y¹ in Formula (A) differs between the first compound and the second compound. In Formula (A), T is a monovalent group, each R¹ is independently a monovalent hydrocarbon group, Y¹ is a monovalent hydrocarbon group or a group represented by Formula (1A), A is a (q+1)-valent linking group, each Y² is independently a group represented by Formula (S1) or Formula (S3), m is a number of 1 or more, and q is an integer of 1 or more.

### CROSS-REFERENCE TO RELATED APPLICATIONS

This application is a Continuation Application of International Application No. PCT/JP2024/035854, filed Oct. 7, 2024, the disclosure of which is incorporated herein by reference in its entirety. Further, this application claims priority from Japanese Patent Application No. 2023-174756, filed Oct. 6, 2023, the disclosure of which is incorporated herein by reference in its entirety.

### TECHNICAL FIELD

The present disclosure relates to a composition, a surface treatment agent, an article, and a method of producing an article.

### BACKGROUND ART

In recent years, in order to improve performance such as appearance and visibility, there has been a demand for a technique that makes fingerprints less likely to adhere to the surface of an article and a technique that facilitates removal of stains. As a specific method, a method of subjecting a surface of an article to a surface treatment using a surface treatment agent is known.

For example, Patent Literature 1 describes a surface treatment agent containing a silane compound having a divalent linear organopolysiloxane group and having a group containing a Si atom to which a hydroxy group or a hydrolyzable group is bonded.

### CITATION LIST

### Patent Literature

Patent Literature 1: WO 2023/017830 A

### SUMMARY OF INVENTION

### Technical Problem

A composition used for a surface treatment agent or the like is required to be capable of forming a surface treatment layer, to which stains such as fingerprints are less likely to adhere, from which stains can be easily wiped off, and which has favorable slipperiness.

The disclosure has been made in view of such circumstances, and an embodiment of the disclosure relates to provision of a composition and a surface treatment agent capable of forming, on a substrate, a surface treatment layer having an antifouling property, fingerprint removability, and slipperiness in a well-balanced manner.

Further, an embodiment of the disclosure relates to provision of an article having a surface treatment layer having an antifouling property, fingerprint removability, and slipperiness in a well-balanced manner, and a method of producing the article.

### Solution to Problem

The disclosure includes the following aspects.
<1>
A composition containing a first compound and a second compound, in which the first compound and the second compound are each represented by Formula (A), and at least one of T or Y¹ in Formula (A) differs between the first compound and the second compound.

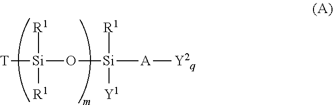

In Formula (A),
T is a monovalent group,
each R¹ is independently a monovalent hydrocarbon group,
Y¹ is a monovalent hydrocarbon group or a group represented by Formula (1A),
A is a (q+1)-valent linking group,
each Y² is independently a group represented by Formula (S1) or Formula (S3),
m is a number of 1 or more, and
q is an integer of 1 or more.

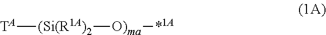

In Formula (1A),
T^{A} is a monovalent group,
each R^{1A} is independently a monovalent hydrocarbon group,
ma is a number of 1 or more, and
*^{1A} is a bonding site to a silicon atom in Formula (A).

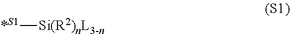

In Formula (S1),
each R² is independently a hydrocarbon group,
each L is independently a hydrolyzable group, a group having a hydrolyzable group, or a hydroxy group,
n is an integer from 0 to 2, and
*^{S1} is a bonding site to a linking group represented by A in Formula (A).

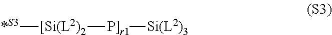

In Formula (S3),
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
*^{S3} is a bonding site to a linking group represented by A in Formula (A).
<2>
The composition according to <1> in which each of the first compound and the second compound is represented by Formula (1), and T in Formula (1) of the first compound is different from T in Formula (1) of the second compound.

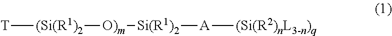

In Formula (1),
T is a monovalent group,
each R¹ is independently a monovalent hydrocarbon group,
A is a (q+1)-valent linking group,
each R² is independently a monovalent hydrocarbon group,
each L is independently a hydrolyzable group, a group having a hydrolyzable group, or a hydroxy group,
m is a number of 1 or more,
each n is independently an integer from 0 to 2, and
q is an integer of 1 or more.
<3>
The composition according to <1> or <2>, in which in Formula (A), T is a methyl group, a linear alkyl group having 2 or more carbon atoms, an alkyl group having 3 or more carbon atoms and having at least one of a branched structure or a cyclic structure, a group represented by Formula (2A), or a group represented by Formula (2B).

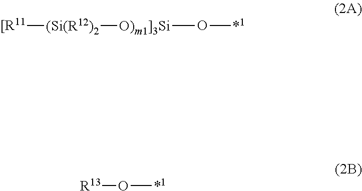

In Formulae (2A) to (2B),
each R¹¹ is independently a monovalent hydrocarbon group or a group R¹⁴₃Si—O—*², each of two or more of the three R¹¹s is R¹⁴₃Si—O—*², each R¹⁴ is independently a monovalent hydrocarbon group or a trialkylsilyloxy group, and *² is a bonding site to a silicon atom in Formula (2A),
each R¹² is independently a monovalent hydrocarbon group,
each m1 is independently a number of 0 or more,
R¹³ is a monovalent cyclic polysiloxane residue or a monovalent cage-like polysiloxane residue, and
*¹ is a bonding site to a silicon atom in Formula (A).
<4>
The composition according to <3>, in which T in Formula (A) of the second compound is a methyl group, a linear alkyl group having 2 or more carbon atoms, or an alkyl group having 3 or more carbon atoms and having at least one of a branched structure or a cyclic structure.
<5>
The composition according to <3> or <4>, in which T in Formula (A) of the first compound is a group represented by Formula (2A) or a group represented by Formula (2B).
<6>
The composition according to <1>, in which Y¹ in Formula (A) of the first compound is different from Y¹ in Formula (A) of the second compound.
<7>
The composition according to <6>, in which
Y¹ in Formula (A) of the first compound is a group represented by Formula (1A), and
Y¹ in Formula (A) of the second compound is a monovalent hydrocarbon group.
<8>
The composition according to any one of <1> to <7>, in which q in Formula (A) is an integer from 1 to 4.
<9>
The composition according to any one of <1> to <8>, in which m in Formula (A) is a number from 1 to 500.
<10>
The composition according to any one of <1> to <9>, further containing a liquid medium.
<11>
A surface treatment agent including the composition according to any one of <1> to <10>.
<12>
A method of producing an article, the method including subjecting a substrate to a surface treatment using the surface treatment agent according to <11> to produce an article having a surface treatment layer formed on the substrate.
<13>
An article including a substrate and a surface treatment layer disposed on the substrate and formed by a surface treatment using the surface treatment agent according to <11>.
<14>
The article according to <13>, which is an optical member.
<15>
The article according to <13>, which is a display or a touch panel.

### Advantageous Effects of Invention

According to an embodiment of the disclosure, a composition and a surface treatment agent capable of forming, on a substrate, a surface treatment layer having an antifouling property, fingerprint removability, and slipperiness in a well-balanced manner are provided.

Further, according to an embodiment of the disclosure, an article having a surface treatment layer having an antifouling property, fingerprint removability, and slipperiness in a well-balanced manner, and a method of producing the article are provided.

### DESCRIPTION OF EMBODIMENTS

Hereinafter, modes for carrying out the embodiments of the disclosure will be described in detail. However, the embodiments of the disclosure are not limited to the following embodiments. In the following embodiments, the components (also including element steps and the like) are not essential unless otherwise specified. The same applies to numerical values and ranges thereof, and do not limit the embodiments of the disclosure.

In the disclosure, a numerical range indicated using “to” includes numerical values described before and after “to” as a minimum value and a maximum value, respectively.

In the numerical ranges described in stages in the disclosure, the upper limit value or the lower limit value described in one numerical range may be replaced with the upper limit value or the lower limit value of a numerical range described in another stage. In addition, in a numerical range described herein, the upper limit or the lower limit of the numerical range may be replaced with a value shown in an example.

In the disclosure, each component may contain a plurality of kinds of corresponding substances. When a plurality of kinds of substances corresponding to each component are present in the composition, the content percentage or content amount of each component means the total content percentage or content amount of the plurality of kinds of substances present in the composition unless otherwise specified.

In the disclosure, the “surface treatment layer” refers to a layer formed on a surface of a substrate by a surface treatment.

In the disclosure, when a compound or a group is represented by specific Formula (X), the compound or the group represented by Formula (X) may be referred to as a compound (X) or a compound X, and a group (X) or a group X, respectively.

In the disclosure, “Me” may refer to a methyl group.

The bonding direction of a divalent group described herein is not limited unless otherwise specified. For example, when Y in a compound represented by the formula “X—Y—Z” is —COO—, Y may be —CO—O— or —O—CO—. Further, the compound may be “X—CO—O—Z” or “X—O—CO—Z”.

### [Composition]

A composition of the disclosure contains a first compound and a second compound, and the first compound and the second compound are each represented by Formula (A), and at least one of T or Y¹ in Formula (A) differs between the first compound and the second compound.

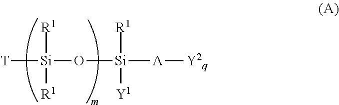

In Formula (A),
T is a monovalent group,
each R¹ is independently a monovalent hydrocarbon group,
Y¹ is a monovalent hydrocarbon group or a group represented by Formula (1A),
A is a (q+1)-valent linking group,
each Y² is independently a group represented by Formula (S1) or Formula (S3),
m is a number of 1 or more, and
q is an integer of 1 or more.

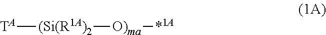

In Formula (1A),
T^{A} is a monovalent group,
each R^{1A} is independently a monovalent hydrocarbon group,
ma is a number of 1 or more, and
*^{1A} is a bonding site to a silicon atom in Formula (A).

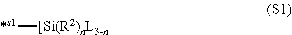

In Formula (S1),
each R² is independently a hydrocarbon group,
each L is independently a hydrolyzable group, a group having a hydrolyzable group, or a hydroxy group,
n is an integer from 0 to 2, and
*^{S1} is a bonding site to a linking group represented by A in Formula (A).

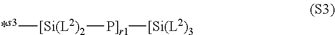

In Formula (S3),
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
*^{S3} is a bonding site to a linking group represented by A in Formula (A).

That is, the composition of the disclosure contains two or more kinds of compounds (A) which are mutually different in at least one of a group T or a group Y¹ in Formula (A).

According to the composition of the disclosure, by incorporation of two or more kinds of compounds (A) which are mutually different in at least one of the group T or the group Y¹, it is possible to form a surface treatment layer having an antifouling property, fingerprint removability, and slipperiness in a well-balanced manner.

In a composition containing only one kind of compound (A), a surface treatment layer excellent in any one of the three properties of an antifouling property, fingerprint removability, and slipperiness is easily obtained, while a surface treatment layer having all the three properties in a well-balanced manner is hardly obtained. The properties of the surface treatment layer formed of a composition containing only one kind of compound (A) vary depending on the kinds of the group T and the group Y¹ of the compound (A). Therefore, it is considered that by using a composition containing two or more kinds of compounds (A), a surface treatment layer having the above three properties in a well-balanced manner is easily obtained as compared with a composition containing only one kind of compound (A).

The composition of the disclosure only needs to contain two or more kinds of compounds (A) which are mutually different in at least one of the group T or the group Y¹. The two or more kinds of compounds (A) may be mutually different in both the group T and the group Y¹, or may be mutually different in only one of the group T and the group Y¹.

Further, the composition of the disclosure only needs to contain two or more kinds of compounds (A) which are mutually different in at least one of the group T or the group Y¹. The composition may contain three or more kinds of compounds (A) which are mutually different in at least one of the group T or the group Y¹. That is, the composition of the disclosure may further contain a third compound in addition to the first compound and the second compound, and the third compound is the compound (A), and may be different from the first compound and the second compound in at least one of the group T or the group Y¹.

In the composition of the disclosure, it is preferable that each of the first compound and the second compound is represented by Formula (1), and T in Formula (1) of the first compound is different from T in Formula (1) of the second compound.

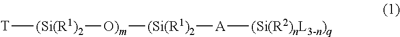

In Formula (1),
T is a monovalent group,
each R¹ is independently a monovalent hydrocarbon group,
A is a (q+1)-valent linking group,
each R² is independently a monovalent hydrocarbon group,
each L is independently a hydrolyzable group, a group having a hydrolyzable group, or a hydroxy group,
m is a number of 1 or more,
each n is independently an integer from 0 to 2, and
q is an integer of 1 or more.

That is, the composition of the disclosure preferably contains two or more kinds of compounds (1) having different groups T from each other. Hereinafter, a composition containing two or more kinds of compounds (1) having different groups T from each other is also referred to as “first composition”.

According to the first composition, by incorporation of two or more kinds of compounds (1) having different groups T from each other, it is possible to form a surface treatment layer having an antifouling property, fingerprint removability, and slipperiness in a well-balanced manner.

The first composition only needs to contain two or more kinds of compounds (1) having different groups T from each other, and may contain three or more kinds of compounds (1) having different groups T from each other. That is, the first composition may further contain a third compound in addition to the first compound and the second compound, and the third compound is the compound (1), and the group T of the third compound may be different from the group T of the first compound and the group T of the second compound.

In the composition of the disclosure, it is also preferable that in the first compound and the second compound, Y¹ in Formula (A) of the first compound is different from Y¹ in Formula (A) of the second compound.

That is, the composition of the disclosure preferably contains two or more kinds of compounds (A) having different groups Y¹ from each other. Hereinafter, a composition containing two or more kinds of compounds (A) having different groups Y¹ from each other is also referred to as “second composition”.

The second composition only needs to contain two or more kinds of compounds (A) having different groups Y¹ from each other. The second composition may contain three or more kinds of compounds (A) which are mutually different in at least one of the group T or the group Y¹, and two or more kinds of compounds (A) among them may have different groups Y¹ from each other. That is, the second composition may further contain a third compound in addition to the first compound and the second compound, and the third compound is the compound (A), and at least one of the group T or the group Y¹ of the third compound may be different from that of the first compound, and at least one of the group T or the group Y¹ of the third compound may be different from that of the second compound.

Hereinafter, each component contained in the composition of the disclosure will be described in detail.

### <Compound (1)>

The compound (1) contained in the first composition which is an example of the composition of the disclosure will be described.

### (Group T)

T in Formula (1) is a monovalent group.

Examples of the monovalent group represented by T in Formula (1) include a methyl group, a linear alkyl group having 2 or more carbon atoms (hereinafter also simply referred to as “linear alkyl group”), an alkyl group having 3 or more carbon atoms and having at least one of a branched structure or a cyclic structure (hereinafter also referred to as “branched cyclic alkyl group”), a group represented by Formula (2A) (hereinafter also referred to as “group (2A)”), and a group represented by Formula (2B) (hereinafter also referred to as “group (2B)”).

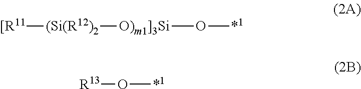

In Formulae (2A) to (2B),
each R¹¹ is independently a monovalent hydrocarbon group or a group R¹⁴₃Si—O—*², each of two or more of the three R¹¹s is R¹⁴₃Si—O—*², each R¹⁴ is independently a monovalent hydrocarbon group or a trialkylsilyloxy group, and *² is a bonding site to a silicon atom in Formula (2A),
each R¹² is independently a monovalent hydrocarbon group,
each m1 is independently a number of 0 or more,
R¹³ is a monovalent cyclic polysiloxane residue or a monovalent cage-like polysiloxane residue, and
*¹ is a bonding site to a silicon atom in Formula (1).

The methyl group, the linear alkyl group, and the branched cyclic alkyl group represented by T in Formula (1) are all unsubstituted alkyl groups.

The number of carbon atoms in the linear alkyl group is, for example, from 2 to 20, and is preferably from 2 to 10, more preferably from 2 to 6, and particularly preferably from 2 to 4.

The branched cyclic alkyl group may be an alkyl group that has a branched structure but does not have a cyclic structure, an alkyl group that has a cyclic structure but does not have a branched structure other than a cyclic structure, or an alkyl group that has both a cyclic structure and a branched structure other than a cyclic structure. Hereinafter, an alkyl group that has a branched structure but does not have a cyclic structure is also referred to as “branched alkyl group”. Further, an alkyl group that has a cyclic structure but does not have a branched structure other than a cyclic structure and an alkyl group that has both a cyclic structure and a branched structure other than a cyclic structure are also collectively referred to as “cyclic alkyl group”.

The number of carbon atoms in the branched alkyl group is, for example, from 3 to 20, preferably from 3 to 10, and more preferably from 3 to 6.

The number of carbon atoms in the cyclic alkyl group is, for example, from 3 to 20, preferably from 3 to 10, and more preferably from 4 to 8. Examples of the cyclic alkyl group include a cycloalkyl group, a cycloalkylalkylene group, and an alkylcycloalkylene group.

Examples of the monovalent hydrocarbon group represented by R¹¹, R¹², or R¹⁴ in Formula (2A) include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group.

The alkyl group contained in the trialkylsilyloxy group represented by R¹⁴ in Formula (2A) may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group. When two or more trialkylsilyloxy groups are present in Formula (2A), the two or more alkylsilyloxy groups may be identical or different from each other, but are preferably identical from the viewpoint of ease of production.
m1 in Formula (2A) is a number of 0 or more, including a number from 0 to 6, and is preferably from 0 to 3, more preferably from 0 to 1, and still more preferably 0.
n1 in Formula (2A) is an integer from 2 to 3, and preferably 3.

Examples of the group (2A) include a group (2A-1) to a group (2A-8).

In Formulae (2A-1) to (2A-8) below, R¹² and m1 have the same meanings as R¹² and m1 in Formula (2A), respectively.

In Formulae (2A-1) to (2A-8) below, each of R¹¹ and R¹⁶ is independently a monovalent hydrocarbon group, and specific examples and preferred examples are the same as those of the monovalent hydrocarbon group represented by R¹¹, R¹², or R¹⁴ in Formula (2A).

In Formulae (2A-1) to (2A-8) below, each R¹⁷ is independently a trialkylsilyloxy group, and specific examples and preferred examples of the alkyl group contained in the trialkylsilyloxy group are the same as those of the alkyl group contained in the trialkylsilyloxy group represented by R¹⁴ in Formula (2A).

In Formulae (2A-1) to (2A-8) below, *¹ has the same meaning as *¹ in Formula (2A).

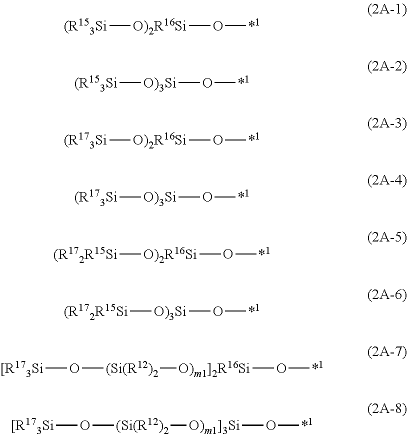

Specific examples of the group (2A) include the following groups. The group (2A) is not limited to these specific examples. In the following formulae, *¹ has the same meaning as
*¹ in Formula (2A).

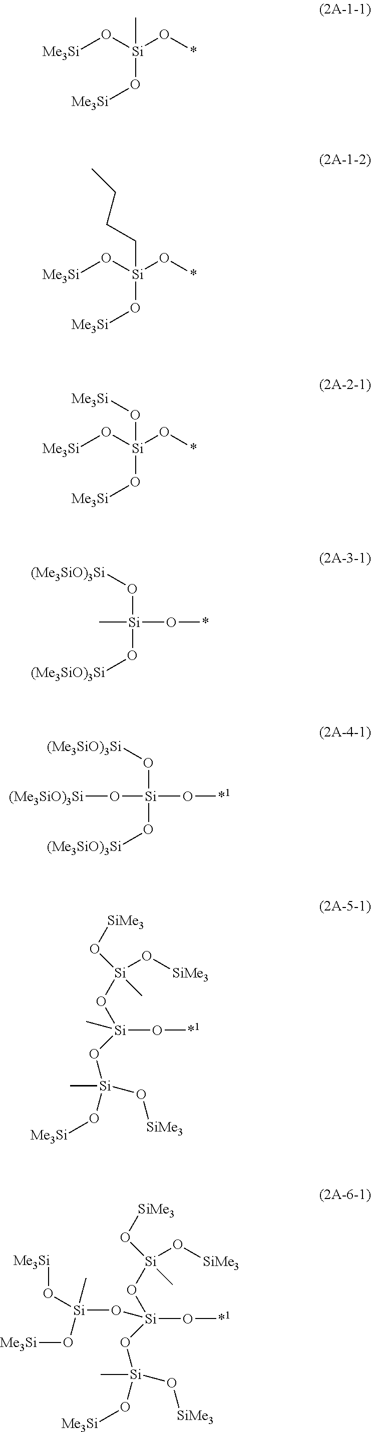

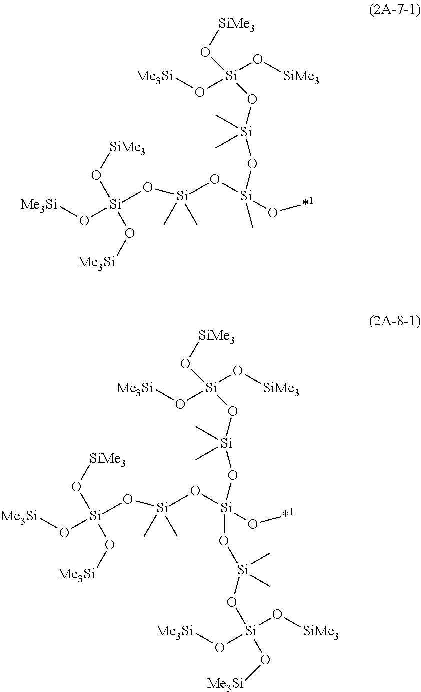

The group (2A) is preferably a group (2A-1), a group (2A-2), a group (2A-3), and a group (2A-4) among groups (2A-1) to (2A-8), more preferably groups in which each of R¹⁵ and R¹⁶ is a methyl group in the group (2A-1), the group (2A-2), the group (2A-3), and the group (2A-4), that is, a group (2A-1-1), a group (2A-2-1), a group (2A-3-1), and a group (2A-4-1), and still more preferably groups in which each R¹⁵ is a methyl group in the group (2A-1) and the group (2A-2), that is, a group (2A-1-1) and a group (2A-2-1).

Examples of the monovalent cyclic polysiloxane residue represented by R¹³ in Formula (2B) include a group represented by Formula (T1) below.

In Formula (T1), each R³ is independently a hydrocarbon group, a hydrocarbon group having a substituent, or a group represented by —O—SiR⁵¹₃, and s is an integer from 1 to 4. Each R⁵¹ is independently a hydrocarbon group or a trialkylsilyloxy group. * represents a bonding site to an adjacent atom.

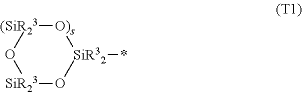

Examples of the hydrocarbon group represented by R³ in Formula (T1) include an aliphatic hydrocarbon group and an aromatic hydrocarbon group. Above all, the hydrocarbon group is preferably an aliphatic hydrocarbon group, and more preferably an alkyl group.

The alkyl group may be any of a linear alkyl group, a branched alkyl group, and a cyclic alkyl group, but is preferably a linear alkyl group. The number of carbon atoms in the alkyl group is preferably from 1 to 10, more preferably from 1 to 8, and still more preferably from 1 to 4. Specifically, the alkyl group represented by R³ is preferably a methyl group, an ethyl group, a n-propyl group, a n-butyl group, an isobutyl group, or a heptyl group, more preferably a methyl group, an ethyl group, a n-propyl group, or a n-butyl group, and still more preferably a methyl group.

Examples of the hydrocarbon group contained in the hydrocarbon group having a substituent represented by R³ in Formula (T1) include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group. The number of carbon atoms in the alkyl group contained in the substituted alkyl group is preferably from 1 to 10, more preferably from 1 to 8, and still more preferably from 2 to 4.

Examples of the substituent in the hydrocarbon group having a substituent represented by R³ in Formula (T1) include a halogen atom, a hydroxy group, an alkoxy group, a trialkylsilyl ether group, a trialkylsilyl group, an amino group, a nitro group, a cyano group, a sulfonyl group, a trifluoromethyl group, and a group represented by —SiR⁵²₃. Each R⁵² is independently a hydrocarbon group or a trialkylsilyloxy group.

Examples of the hydrocarbon group represented by R⁵² include those the same as the hydrocarbon group represented by R³.

The alkyl group contained in the trialkylsilyloxy group represented by R⁵² may be any of a linear alkyl group, a branched alkyl group, and a cyclic alkyl group, but is preferably a linear alkyl group. The number of carbon atoms in the alkyl group is preferably from 1 to 10, more preferably from 1 to 8, still more preferably from 1 to 4, and particularly preferably 1. The three alkyl groups contained in the trialkylsilyloxy group may be identical or different from each other.

The three R⁵²s may be identical or different from each other, but are preferably identical from the viewpoint of ease of production.

In the group represented by —O—SiR⁵¹₃ represented by R³ in Formula (T1), each R⁵¹ is independently a hydrocarbon group or a trialkylsilyloxy group. Examples of the hydrocarbon group represented by R⁵¹ include those the same as the hydrocarbon group represented by R³. Examples of the trialkylsilyloxy group represented by R⁵¹ include those the same as the trialkylsilyloxy group represented by R⁵².

A plurality of R³s in Formula (T1) may be identical or different from each other, but are preferably identical from the viewpoint of ease of production.

Examples of the monovalent cyclic polysiloxane residue include the following groups. In the following formulae, * represents a bonding site to an adjacent atom.

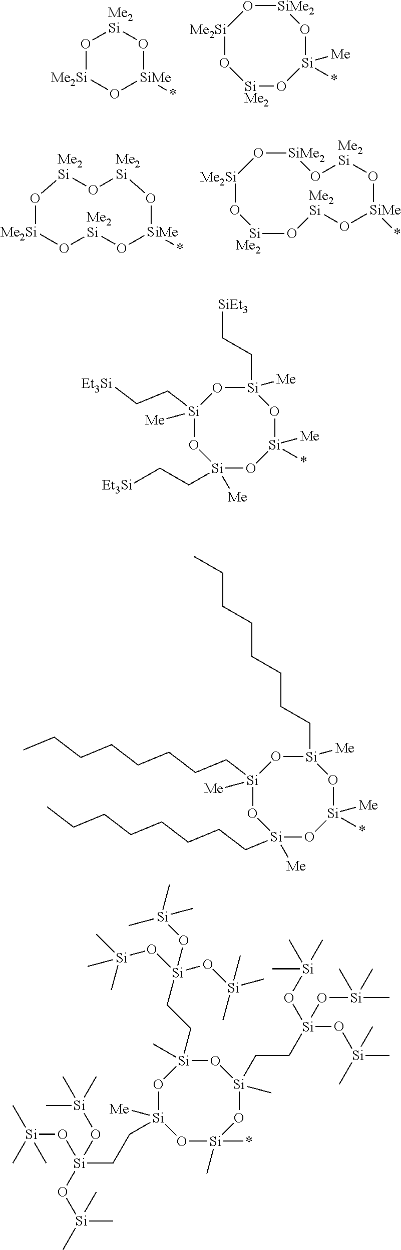

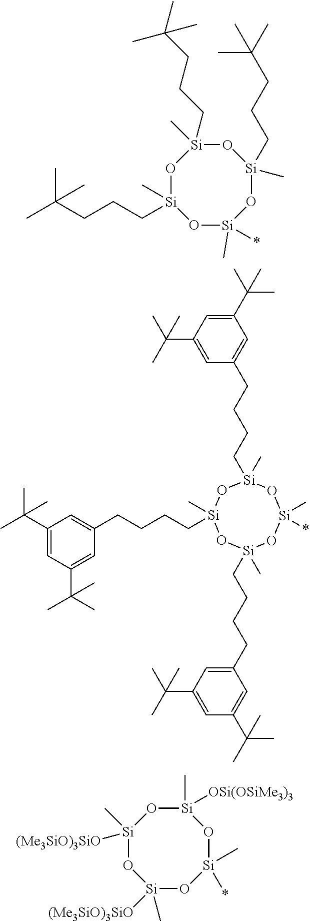

Examples of the monovalent cage-like polysiloxane residue represented by R¹³ in Formula (2B) include a group represented by Formula (T2) below.

In Formula (T2), each R⁴ is independently a hydrocarbon group or a trialkylsilyloxy group. * represents a bonding site to an adjacent atom.

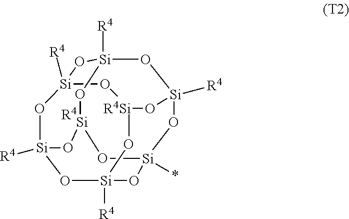

Examples of the hydrocarbon group represented by R⁴ in Formula (T2) include an aliphatic hydrocarbon group and an aromatic hydrocarbon group. Above all, the hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group or a branched alkyl group, more preferably a methyl group, an ethyl group, a n-propyl group, a n-butyl group, or an isobutyl group, and still more preferably an isobutyl group.

The alkyl group contained in the trialkylsilyloxy group represented by R⁴ in Formula (T2) may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group. When R⁴ is a trialkylsilyloxy group, the three alkylsilyloxy groups may be identical or different from each other, but are preferably identical from the viewpoint of ease of production.

Examples of the monovalent cage-like polysiloxane residue include the following groups. In the following formulae, * represents a bonding site to an adjacent atom.

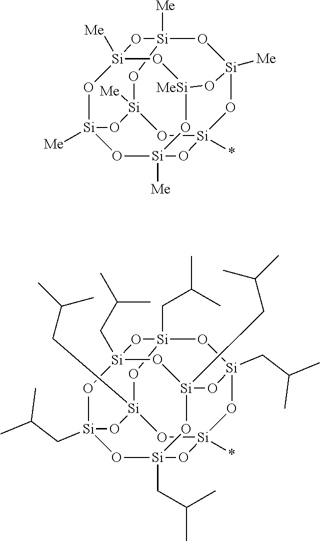

T in Formula (1) may be a monovalent group containing at least one selected from the group consisting of Ge and Sn to which a hydroxy group or a hydrolyzable group is not directly bonded. The monovalent group containing at least one selected from the group consisting of Ge and Sn to which a hydroxy group or a hydrolyzable group is not directly bonded may or may not contain Ge or Sn to which a hydroxy group or a hydrolyzable group is directly bonded.

In one aspect, T in Formula (1) may be a group having a group (c).

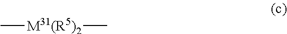

In Formula (c),
M³¹ is Sn or Ge,
each R⁵ is independently a hydrocarbon group, a trialkylsilyloxy group, or (R⁷)₃M³¹O—.
   In the case of having a plurality of M³¹s in Formula (c), each is independently Sn or Ge, but is preferably the same element. R⁷ is a hydrocarbon group, preferably an alkyl group, and the number of carbon atoms thereof is preferably from 1 to 6, more preferably from 1 to 4, and still more preferably from 1 to 2.

M³¹ is Sn or Ge. M³¹ is preferably Ge from the viewpoint that Ge has a larger atomic size than Sn, can further reduce surface free energy, and can form a surface treatment layer having excellent fingerprint removability.

R⁵ is a hydrocarbon group, a trialkylsilyloxy group, or (R⁷)₃M³¹O—.

Examples of the hydrocarbon group include an alkyl group, a cycloalkyl group, an alkenyl group, and an allyl group, and from the viewpoint of ease of synthesis and the like, a saturated hydrocarbon group is preferable, and an alkyl group is more preferable. The number of carbon atoms in R⁵ is preferably from 1 to 6, more preferably from 1 to 3, and particularly preferably —CH₃ or —CH₂CH₃.

The trialkylsilyloxy group is preferably a group represented by —O—SiR⁴⁰₃. Each R⁴⁰ is independently a hydrocarbon group. The hydrocarbon group of R⁴⁰ is preferably an alkyl group or an aryl group, and more preferably an alkyl group. The number of carbon atoms in R⁴⁰ is preferably from 1 to 6, more preferably from 1 to 4, and still more preferably from 1 to 2. Specific examples of the hydrocarbon group in R⁴⁰ include —CH₃, —CH₂CH₃, and —C(CH₃)₃.

Examples of the group having the group (c) include a group in which an organic group is linked to one side or both sides of M³¹ in the group (c). Examples of the organic group include a monovalent organic group, a divalent organic group, and any combination thereof. However, a monovalent organic group is not linked to both sides.

Examples of the monovalent organic group include a hydrocarbon group and a trialkylsilyloxy group. The group (c) may be M³¹(R⁵)₃—, may be M³¹(Me)₃-, or may be Ge(Me)₃-.

Examples of the divalent organic group include a chain hydrocarbon group; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of a chain hydrocarbon group or between carbon atoms; and any combination thereof. R^{d} is a hydrogen atom or an alkyl group (preferably having from 1 to 10 carbon atoms).

From the viewpoint of obtaining a surface treatment layer having an excellent antifouling property, at least one kind of group T of the compound (1) contained in the first composition is preferably at least one kind selected from the group consisting of a methyl group, a group (2A), and a group (2B), more preferably at least one kind selected from the group consisting of a group (2A) and a group (2B), and still more preferably a group (2A).

From the viewpoint of obtaining a surface treatment layer having excellent fingerprint removability, at least one kind of group T of the compound (1) contained in the first composition is preferably at least one kind selected from the group consisting of a methyl group, a group (2A), and a group (2B), and more preferably a methyl group.

From the viewpoint of obtaining a surface treatment layer having excellent slipperiness, at least one kind of group T of the compound (1) contained in the first composition is preferably at least one kind selected from the group consisting of a methyl group, a linear alkyl group, and a branched cyclic alkyl group, more preferably at least one kind selected from the group consisting of a linear alkyl group and a branched cyclic alkyl group, and still more preferably a linear alkyl group.

Examples of the combination of the group T of the first compound and the group T of the second compound include the following combinations T2-1 to T2-14. However, the group T of the first compound and the group T of the second compound are groups having different structures.

TABLE 1

| Combination | Group T of first compound | Group T of second compound |
|---|---|---|
| T2-1 | Linear alkyl group | Methyl group |
| T2-2 | Branched cyclic alkyl group | Methyl group |
| T2-3 | Group (2A) | Methyl group |
| T2-4 | Group (2B) | Methyl group |
| T2-5 | Linear alkyl group | Linear alkyl group |
| T2-6 | Branched cyclic alkyl group | Linear alkyl group |
| T2-7 | Group (2A) | Linear alkyl group |
| T2-8 | Group (2B) | Linear alkyl group |
| T2-9 | Branched cyclic alkyl group | Branched cyclic alkyl group |
| T2-10 | Group (2A) | Branched cyclic alkyl group |
| T2-11 | Group (2B) | Branched cyclic alkyl group |
| T2-12 | Group (2A) | Group (2A) |
| T2-13 | Group (2B) | Group (2A) |
| T2-14 | Group (2B) | Group (2B) |

The group T of the second compound is preferably a methyl group, a linear alkyl group, or a branched cyclic alkyl group from the viewpoint of obtaining a surface treatment layer having excellent slipperiness while also having an antifouling property and fingerprint removability in a well-balanced manner.

Examples of the combination of the group T of the first compound and the group T of the second compound in a case in which the group T of the second compound is a methyl group, a linear alkyl group, or a branched cyclic alkyl group include combinations T2-1 to T2-11. Above all, combinations T2-1 to T2-4, T2-7 to T2-8, and T2-10 to T2-11 are preferable. Combinations T2-1, T2-2, T2-3, T2-7, and T2-10 are more preferable, and combinations T2-1, T2-3, and T2-7 are still more preferable.

The group T of the first compound is preferably a group (2A) or a group (2B) from the viewpoint of obtaining a surface treatment layer having an excellent antifouling property while also having fingerprint removability and slipperiness in a well-balanced manner.

Examples of the combination of the group T of the first compound and the group T of the second compound in a case in which the group T of the first compound is a group (2A) or a group (2B) include combinations T2-3 to T2-4, T2-7 to T2-8, and T2-10 to T2-14. Above all, combinations T2-3 to T2-4, T2-7 to T2-8, and T2-10 to T2-11 are preferable, and combinations T2-3, T2-7, and T2-10 are more preferable.

It is preferable that the group T of the first compound is a group (2A) or a group (2B), and the group T of the second compound is a methyl group, a linear alkyl group, or a branched cyclic alkyl group from the viewpoint of obtaining a surface treatment layer having an antifouling property, fingerprint removability, and slipperiness in a well-balanced manner.

Examples of the combination of the group T of the first compound and the group T of the second compound in the above case include combinations T2-3 to T2-4, T2-7 to T2-8, and T2-10 to T2-11. Above all, combinations T2-3, T2-7, and T2-10 are preferable, and combinations T2-3 and T2-7 are more preferable.

In the combinations T2-3 and T2-7, it is preferable that the group T of the first compound is the group (2A-1) or the group (2A-2), and the group T of the second compound is a methyl group or a linear alkyl group. It is more preferable that the group T of the first compound is the group (2A-1-1) or the group (2A-2-1), and the group T of the second compound is a methyl group or a linear alkyl group. It is still more preferable that the group T of the first compound is the group (2A-1-1) or the group (2A-2-1), and the group T of the second compound is a methyl group or a linear alkyl group having from 2 to 4 carbon atoms. It is particularly preferable that the group T of the first compound is the group (2A-1-1) or the group (2A-2-1), and the group T of the second compound is a methyl group or a n-butyl group. It is extremely preferable that the group T of the first compound is the group (2A-1-1) or the group (2A-2-1), and the group T of the second compound is a methyl group.

When the first composition further contains the third compound, examples of the combination of the combination of the group T of the first compound and the group T of the second compound with the group T of the third compound include the following combinations T3-1 to T3-7. However, the group T of the third compound is a group having a structure different from the group T of the first compound and the group T of the second compound.

TABLE 2

| Combi- | Combination of group T of first compound | Group T of |
|---|---|---|
| nation | and group T of second compound | third compound |
| T3-1 | Any of combinations T2-5 to T2-6 and | Methyl group |
| | T2-9 | |
| T3-2 | Any of combinations T2-7 to T2-8 and | Methyl group |
| | T2-10 to T2-11 | |
| T3-3 | Any of combinations T2-12 to T2-14 | Methyl group |
| T3-4 | Any of combinations T2-5 to T2-6 and | Either of linear alkyl |
| | T2-9 | group and branched |
| | | cyclic alkyl group |
| T3-5 | Any of combinations T2-7 to T2-8 and | Either of linear alkyl |
| | T2-10 to T2-11 | group and branched |
| | | cyclic alkyl group |
| T3-6 | Any of combinations T2-12 to T2-14 | Either of linear alkyl |
| | | group and branched |
| | | cyclic alkyl group |
| T3-7 | Any of combinations T2-12 to T2-14 | Either of group (2A) |
| | | and group (2B) |

The combination of the first compound, the second compound, and the third compound is preferably a combination T3-2 from the viewpoint of obtaining a surface treatment layer having an excellent antifouling property while also having fingerprint removability and slipperiness in a well-balanced manner.

In the combination T3-2, the combination of the first compound, the second compound, and the third compound is preferably a combination of the combination T2-7 and a methyl group, or a combination of the combination T2-8 and a methyl group, and more preferably a combination of the combination T2-7 and a methyl group.

In the combination of the combination T2-7 and a methyl group, it is preferable that the group T of the first compound is the group (2A-1) or the group (2A-2), the group T of the second compound is a linear alkyl group, and the group T of the third compound is a methyl group. It is more preferable that the group T of the first compound is the group (2A-1-1) or the group (2A-2-1), the group T of the second compound is a linear alkyl group, and the group T of the third compound is a methyl group. It is still more preferable that the group T of the first compound is the group (2A-1-1) or the group (2A-2-1), the group T of the second compound is a linear alkyl group having from 2 to 4 carbon atoms, and the group T of the third compound is a methyl group. It is particularly preferable that the group T of the first compound is the group (2A-1-1) or the group (2A-2-1), the group T of the second compound is a n-butyl group, and the group T of the third compound is a methyl group.

### (Group R¹ and m)

Each R¹ in Formula (1) is independently a monovalent hydrocarbon group.

Examples of the monovalent hydrocarbon group represented by R¹ in Formula (1) include an aliphatic hydrocarbon group and an aromatic hydrocarbon group. Above all, the monovalent hydrocarbon group is preferably an aliphatic hydrocarbon group, and more preferably an alkyl group. The alkyl group may be any of a linear alkyl group, a branched alkyl group, and a cyclic alkyl group, but is preferably a linear alkyl group, more preferably a methyl group, an ethyl group, a n-propyl group, or a n-butyl group, and still more preferably a methyl group. The aromatic hydrocarbon group is preferably a phenyl group.

The (2m+1) number of R¹s in Formula (1) may all be the same group, or some of them may be different groups. Examples of a case in which some are different groups include a case in which some of the (2m+1) number of R¹s are n-butyl groups and the rest are methyl groups.

The group R¹ in the first compound and the group R¹ in the second compound may be the same as or different from each other. The group R¹ in the first compound and the group R¹ in the second compound are preferably the same from the viewpoint of improving the balance among an antifouling property, fingerprint removability, and slipperiness. When the first composition contains the third compound, the group R¹ in the first compound, the group R¹ in the second compound, and the group R¹ in the third compound may all be the same as each other, only two of them may be the same as each other, or all may be different from each other. The group R¹ in the first compound, the group R¹ in the second compound, and the group R¹ in the third compound are all preferably the same as each other from the viewpoint of improving the balance among an antifouling property, fingerprint removability, and slipperiness.

m in Formula (1) is a number of 1 or more, preferably from 1 to 600, more preferably from 1 to 500, still more preferably from 3 to 500, particularly preferably from 9 to 50, extremely preferably from 11 to 30, and most preferably from 11 to 25. In another aspect, m in Formula (1) is preferably from 1 to 10, and more preferably from 1 to 4. m in the first compound and m in the second compound may be the same as or different from each other. When the first composition contains the third compound, m in the first compound, m in the second compound, and m in the third compound may all be the same as each other, only two of them may be the same as each other, or all may be different from each other.

### (Group R², Group L, n, and q)

Each R² in Formula (1) is independently a monovalent hydrocarbon group.

The monovalent hydrocarbon group represented by R² in Formula (1) is preferably a monovalent saturated hydrocarbon group. The number of carbon atoms in R² is preferably from 1 to 6, more preferably from 1 to 3, and still more preferably from 1 to 2.

Each L in Formula (1) is independently a hydrolyzable group, a group having a hydrolyzable group, or a hydroxy group.

The hydrolyzable group is a group that becomes a hydroxy group by a hydrolysis reaction. That is, a hydrolyzable silyl group represented by Si-L (L is a hydrolyzable group) becomes a silanol group represented by Si—OH by a hydrolysis reaction. Silanol groups further react between the silanol groups to form a Si—O—Si bond. The silanol group can form a Si—O—Si bond by a dehydration condensation reaction with a silanol group derived from an oxide present on the surface of the substrate.

Examples of the hydrolyzable group include an alkoxy group, an aryloxy group, a halogen atom, an acyl group, an acyloxy group, an amino group, —O—N═CR^{r}₂, and an isocyanato group (—NCO). The alkoxy group is preferably an alkoxy group having from 1 to 4 carbon atoms. The aryloxy group is preferably an aryloxy group having from 3 to 10 carbon atoms. However, the aryl group of the aryloxy group includes a heteroaryl group. The halogen atom is preferably a chlorine atom. The acyl group is preferably an acyl group having from 1 to 6 carbon atoms. The acyloxy group is preferably an acyloxy group having from 1 to 6 carbon atoms. Each R^{r} is independently an alkyl group having from 1 to 10 carbon atoms.

Examples of the group having a hydrolyzable group include a group having a hydrolyzable group exemplified above, and examples thereof include a group in which a hydrolyzable group is bonded to a linking group. Examples of the linking group include an alkylene group, —O—, and any combination thereof.

The group having a hydrolyzable group is preferably —O-L^{A}-L^{B}. L^{A} is an alkylene group, and L^{B} is a hydrolyzable group. The number of carbon atoms in the alkylene group is preferably from 1 to 10. The hydrolyzable group represented by L^{B} has the same meaning as the hydrolyzable group described above, and the preferred embodiment is also the same. Examples of —O-L^{A}-L^{B} include an alkoxyalkyleneoxy group. The alkoxyalkyleneoxy group is preferably a group in which an alkoxy group having from 1 to 4 carbon atoms is bonded to a carbon atom of an alkyleneoxy group having from 1 to 10 carbon atoms. Specific examples of the alkoxyalkyleneoxy group include a 2-methoxyethoxy group.

L in Formula (1) is preferably an alkoxy group having from 1 to 4 carbon atoms or a halogen atom from the viewpoint of ease of production of the compound. L is preferably an alkoxy group having from 1 to 4 carbon atoms, and more preferably an ethoxy group or a methoxy group from the viewpoint that there is less outgas generation during coating and the compound has more excellent storage stability.

The group L in the first compound and the group L in the second compound may be the same as or different from each other. The group L in the first compound and the group L in the second compound are preferably the same from the viewpoint of improving the balance among an antifouling property, fingerprint removability, and slipperiness. When the first composition contains the third compound, the group L in the first compound, the group L in the second compound, and the group L in the third compound may all be the same as each other, only two of them may be the same as each other, or all may be different from each other. The group L in the first compound, the group L in the second compound, and the group L in the third compound are all preferably the same as each other from the viewpoint of improving the balance among an antifouling property, fingerprint removability, and slipperiness.

Each n in Formula (1) is independently an integer from 0 to 2, preferably 0 or 1, and more preferably 0. The presence of a plurality of Ls makes the adhesion of the surface treatment layer to the substrate stronger.

n in the first compound and n in the second compound may be the same as or different from each other. n in the first compound and n in the second compound are preferably the same from the viewpoint of improving the balance among an antifouling property, fingerprint removability, and slipperiness. When the first composition contains the third compound, n in the first compound, n in the second compound, and n in the third compound may all be the same as each other, only two of them may be the same as each other, or all may be different from each other. n in the first compound, n in the second compound, and n in the third compound are all preferably the same as each other from the viewpoint of improving the balance among an antifouling property, fingerprint removability, and slipperiness.

When n is 1 or less, a plurality of Ls present in one molecule may be the same or different from each other. From the viewpoint of ease of availability of the raw material and ease of production of the compound, the plurality of Ls are preferably the same. When n is 2, a plurality of R²s present in one molecule may be the same or different from each other. From the viewpoint of ease of availability of the raw material and ease of production of the compound, the plurality of R²s are preferably the same.

The group R² in the first compound and the group R² in the second compound may be the same as or different from each other. The group R² in the first compound and the group R² in the second compound are preferably the same from the viewpoint of improving the balance among an antifouling property, fingerprint removability, and slipperiness. When the first composition contains the third compound, the group R² in the first compound, the group R² in the second compound, and the group R² in the third compound may all be the same as each other, only two of them may be the same as each other, or all may be different from each other. The group R² in the first compound, the group R² in the second compound, and the group R² in the third compound are all preferably the same as each other from the viewpoint of improving the balance among an antifouling property, fingerprint removability, and slipperiness.

Hereinafter, the group represented by [—Si(R²)ₙL₃₋ₙ] in Formula (1) is also referred to as “reactive silyl group”.

From the viewpoint that the surface treatment layer has excellent uniformity and durability, the reactive silyl group is preferably an alkoxysilyl group or a trichlorosilyl group. The reactive silyl group is more preferably an alkoxysilyl group from the viewpoint of ease of handling of a by-product generated in a reaction with the substrate. The alkoxysilyl group is preferably a dialkoxysilyl group or a trialkoxysilyl group, and more preferably a trialkoxysilyl group.

When there is a plurality of reactive silyl groups in one molecule, the plurality of reactive silyl groups may be the same or different from each other. From the viewpoint of ease of availability of the raw material and ease of production of the compound, the plurality of reactive silyl groups are preferably the same.

The reactive silyl group in the first compound and the reactive silyl group in the second compound may be the same as or different from each other. The reactive silyl group in the first compound and the reactive silyl group in the second compound are preferably the same from the viewpoint of improving the balance among an antifouling property, fingerprint removability, and slipperiness. When the first composition contains the third compound, the reactive silyl group in the first compound, the reactive silyl group in the second compound, and the reactive silyl group in the third compound may all be the same as each other, only two of them may be the same as each other, or all may be different from each other. The reactive silyl group in the first compound, the reactive silyl group in the second compound, and the reactive silyl group in the third compound are all preferably the same as each other from the viewpoint of improving the balance among an antifouling property, fingerprint removability, and slipperiness.

q in Formula (1) is an integer of 1 or more. q is preferably from 1 to 18, more preferably from 1 to 12, still more preferably from 1 to 8, particularly preferably from 1 to 6, and extremely preferably from 1 to 4 from the viewpoint that the surface treatment layer has more excellent wear resistance. In one aspect, q is preferably from 2 to 18, more preferably from 2 to 12, still more preferably from 2 to 8, and particularly preferably from 2 to 6. q in the first compound and q in the second compound may be the same as or different from each other. q in the first compound and q in the second compound are preferably the same from the viewpoint of improving the balance among an antifouling property, fingerprint removability, and slipperiness. When the first composition contains the third compound, q in the first compound, q in the second compound, and q in the third compound may all be the same as each other, only two of them may be the same as each other, or all may be different from each other. q in the first compound, q in the second compound, and q in the third compound are all preferably the same as each other from the viewpoint of improving the balance among an antifouling property, fingerprint removability, and slipperiness.

### (Group A)

Examples of the (q+1)-valent linking group represented by A in Formula (1) include a (q+1)-valent linking group represented by the following Formula (3).

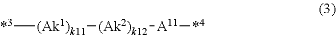

In Formula (3),
Ak¹ is an alkylene chain,
Ak² is a phenylene group,
A¹¹ is a single bond or a (q+1)-valent linking group,
each of k11 and k12 is independently 0 or 1,
*³ is a bonding site to Si(R¹)₂ in Formula (1), and
*⁴ is a bonding site to Si(R²)ₙL₃₋ₙ in Formula (1).

The number of carbon atoms in the alkylene chain represented by Ak¹ in Formula (3) is preferably from 1 to 30, more preferably from 1 to 20, still more preferably from 4 to 20, and particularly preferably from 5 to 15.

The phenylene group represented by Ak² in Formula (3) may be any of an o-phenylene group, a m-phenylene group, and a p-phenylene group, and is preferably a p-phenylene group.

In Formula (3), k11 is preferably 1.

In Formula (3), k12 is preferably 0.

When both k11 and k12 in Formula (3) are 0, A¹¹ is a (q+1)-valent linking group.

When q in Formula (1) is an integer of 1 or more, A¹¹ is a (q+1)-valent linking group.

The (q+1)-valent linking group represented by A¹¹ in Formula (3) only needs to be a group that does not impair the effects of the disclosure, and examples thereof include an alkylene group which may have an ether oxygen atom or a divalent organopolysiloxane residue, a carbon atom, a nitrogen atom, a silicon atom, a divalent to octavalent organopolysiloxane residue, and groups obtained by removing Si(R²)ₙL₃₋ₙ from Formula (3-1A), Formula (3-1), and Formulae (3-1A-1) to (3-1A-7) described later.

A¹¹ may include a trypticene structure. The trypticene structure refers to a partial structure obtained by removing two or more hydrogen atoms from trypticene.

A¹¹ may be a group (g2-1) to a group (g2-14) described later.

The group represented by -A¹¹-(Si(R²)ₙL₃₋ₙ)_{q} is preferably a group (3-1A) or a group (3-1), and more preferably a group (3-1A).

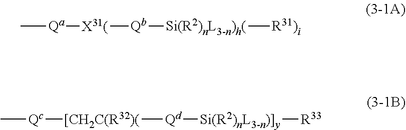

In Formula (3-1A) and Formula (3-1B), the definitions of R², L, and n are as described above.

In Formula (3-1A), Q^{a} is a single bond or a divalent linking group.

However, when k11 is 1 and k12 is 0 in Formula (3), the terminal of Q^{a} on the side bonded to Ak¹ is not an alkylene group.

Examples of the divalent linking group include a divalent hydrocarbon group, a divalent heterocyclic group, —O—, —S—, —SO₂—, —N(R^{d})—, —C(O)—, —Si(R^{a})₂—, and a group obtained by combining two or more thereof.

The divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms in the alkylene group is preferably from 1 to 30, more preferably from 1 to 20, still more preferably from 4 to 20, and particularly preferably from 5 to 15. The divalent aromatic hydrocarbon group is preferably one having from 5 to 20 carbon atoms, and examples thereof include a phenylene group. In addition, the divalent aromatic hydrocarbon group may be an alkenylene group having from 2 to 20 carbon atoms or an alkynylene group having from 2 to 20 carbon atoms.

R^{a} is an alkyl group (preferably having from 1 to 10 carbon atoms) or a phenyl group. R^{d} is a hydrogen atom or an alkyl group (preferably having from 1 to 10 carbon atoms).

Examples of the group obtained by combining two or more thereof include —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and an alkylene group-Si(R^{a})₂-phenylene group-Si(R^{a})₂.

In particular, when k11 is 1 and k12 is 0 in Formula (3), Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—. Q^{a} is more preferably —OC(O)—, an alkylene group having —C(O)N(R^{d})—, an alkylene group having —OC(O)N(R^{d})—, an alkylene group having an ether oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d}). Q^{a} is still more preferably an alkylene group having —C(O)O— or an alkylene group having —C(O)N(R^{d})—.

When both k11 and k12 in Formula (3) are 0, Q^{a} is preferably a divalent hydrocarbon group other than an alkylene group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, or an alkylene group having —SO₂N(R^{d})—, and more preferably —C(O)—.

When k12 is 1 in Formula (3), Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an ether oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—. Q^{a} is more preferably —OC(O)—, an alkylene group having —C(O)N(R^{d})—, an alkylene group having —OC(O)N(R^{d})—, an alkylene group having an ether oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—. Q^{a} is still more preferably an alkylene group having —C(O)O— or an alkylene group having —C(O)N(R^{d})—.

In Formula (3-1A), X³¹ is a single bond, an alkylene group, a carbon atom, a nitrogen atom, a silicon atom, a divalent to octavalent organopolysiloxane residue, or a group having a (h+i+1)-valent ring.

However, when k11 is 1 and k12 is 0 in Formula (3), and Q^{a} is a single bond, the terminal of X³¹ on the side bonded to Ak¹ is not an alkylene group.

When both k11 and k12 in Formula (3) are 0, and Q^{a} is a single bond, the terminal of X³¹ on the side bonded to Si is not a divalent linear organopolysiloxane residue. In cases other than the above, the terminal of X³¹ may be an alkylene group or a divalent linear organopolysiloxane residue.

The alkylene group may have —O—, a silphenylene backbone group, a divalent organopolysiloxane residue, or a dialkylsilylene group. The alkylene group may have a plurality of groups selected from the group consisting of —O—, a silphenylene backbone group, a divalent organopolysiloxane residue, and a dialkylsilylene group.

The number of carbon atoms in the alkylene group represented by X³¹ is preferably from 1 to 20, and more preferably from 1 to 10.

Examples of the divalent to octavalent organopolysiloxane residue include a divalent organopolysiloxane residue and a (w2+1)-valent organopolysiloxane residue described later.

In Formula (3-1A), when X³¹ is a group having a (h+i+1)-valent ring, Q^{a} (-Q^{b}-Si(R²)ₙL₃₋ₙ), and R³¹ are directly bonded to atoms included in the ring. However, the ring is a ring other than an organopolysiloxane ring.

The ring in X³¹ may be any of a monocyclic ring, a fused polycyclic ring, a bridged ring, a spiro ring, and an assembled polycyclic ring. The atoms included in the ring may be a carbocyclic ring formed only of carbon atoms, or may be a heterocyclic ring formed of a heteroatom having a valence of 2 or more and a carbon atom. The bond between atoms included in the ring may be a single bond or a multiple bond. The ring may be an aromatic ring or a non-aromatic ring.

The monocyclic ring is preferably a 4- to 8-membered ring, and more preferably a 5- or 6-membered ring. The fused polycyclic ring is preferably a fused polycyclic ring in which two or more 4- to 8-membered rings are fused, and more preferably a fused polycyclic ring in which two or three rings selected from 5- and 6-membered rings are bonded, and a fused polycyclic ring in which one or two rings selected from 5- and 6-membered rings and one 4-membered ring are bonded. The bridged ring is preferably a bridged ring having a 5- or 6-membered ring as the largest ring, and the spiro ring is preferably a spiro ring formed of two 4- to 6-membered rings. The assembled polycyclic ring is preferably an assembled polycyclic ring in which two or three rings selected from 5- and 6-membered rings are bonded via a single bond, one to three carbon atoms, or one heteroatom having a valence of 2 or 3. In the assembled polycyclic ring, any of Q^{a}, (-Q^{b}-Si(R²)ₙL₃₋ₙ), and R³¹ (when i=1 or more) is preferably bonded to each ring.

As the heteroatom included in the ring, a nitrogen atom, an oxygen atom, and a sulfur atom are preferable, and a nitrogen atom and an oxygen atom are more preferable. The number of heteroatoms included in the ring is preferably 3 or less. When the number of heteroatoms included in the ring is 2 or more, those heteroatoms may be different.

The ring in X³¹ is preferably one selected from the group consisting of a 3- to 8-membered aliphatic ring, a benzene ring, a 3- to 8-membered heterocyclic ring, a fused ring in which 2 or 3 of these rings are fused, a bridged ring having a 5- or 6-membered ring as the largest ring, and an assembled polycyclic ring, which has two or more of these rings, and in which a linking group is a single bond, an alkylene group having 3 or less carbon atoms, an oxygen atom, or a sulfur atom, from the viewpoint that the compound is easily produced and the surface treatment layer has more excellent wear resistance.

Preferred rings are a benzene ring, a 5- or 6-membered aliphatic ring, a 5- or 6-membered heterocyclic ring having a nitrogen atom or an oxygen atom, and a fused ring of a 5- or 6-membered carbocyclic ring and a 4- to 6-membered heterocyclic ring.

Specific examples of the ring include the following rings, a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Rings having an oxo group (═O) are also shown below.

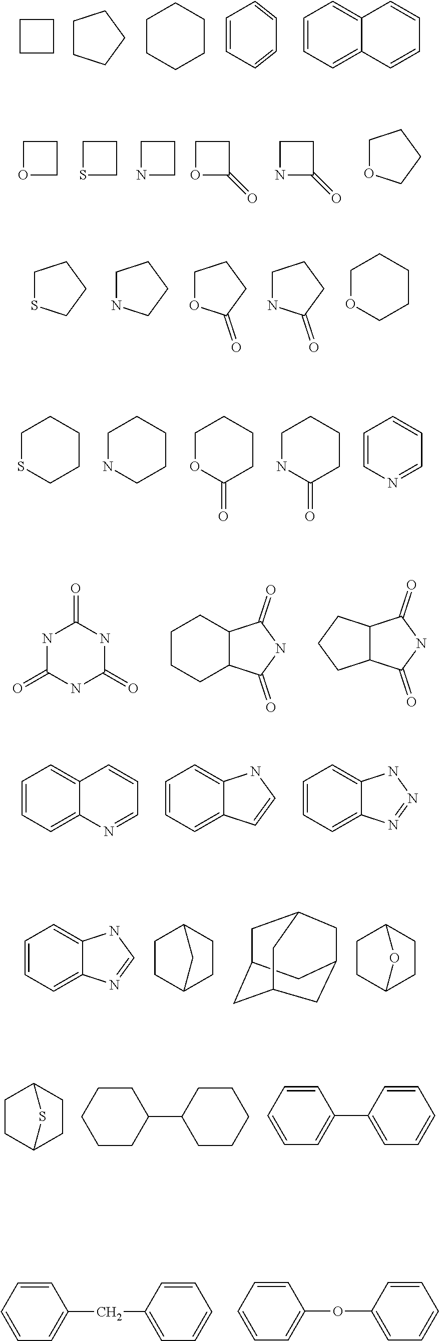

A non-ring-forming bond of an atom included in the ring in X³¹ is a bond bonded to Q^{a} (-Q^{b}-Si(R²)ₙL₃₋ₙ), or R³¹. When there is a remaining bond, the remaining bond is bonded to a hydrogen atom or a substituent. Examples of the substituent include a halogen atom, an alkyl group (an ether oxygen atom may be contained between carbon atoms), a cycloalkyl group, an alkenyl group, an allyl group, an alkoxy group, or an oxo group (═O).

When one of the carbon atoms included in the ring has two bonds bonded to Q^{a} (-Q^{b}-Si(R²)ₙL₃₋ₙ), or R³¹, Q^{a} and (-Q^{b}-Si(R²)ₙL₃₋ₙ) may be bonded to the one carbon atom, or two (-Q^{b}-Si(R²)ₙL₃₋ₙ)s may be bonded thereto. Q^{a} and (-Q^{b}-Si(R²)ₙL₃₋ₙ) or R³¹ are preferably bonded to different ring-forming atoms. Each of the h number of (-Q^{b}-Si(R²)ₙL₃₋ₙ)s may be bonded to a different ring-forming atom, or two of them may be bonded to one ring-forming carbon atom. Further, there may be two or more ring-forming carbon atoms to which two (-Q^{b}-Si(R²)ₙL₃₋ₙ)s are bonded. Each of i number of R³¹s may be bonded to a different ring-forming atom, or two of them may be bonded to one ring-forming carbon atom. Further, there may be two or more ring-forming carbon atoms to which two R³¹s are bonded.

Above all, from the viewpoint of improving the wear resistance of the surface treatment layer, X³¹ is preferably a carbon atom, a nitrogen atom, a silicon atom, a tetravalent to octavalent organopolysiloxane residue, or a group having a (h+i+1)-valent ring, and more preferably a carbon atom.

In Formula (3-1A), Q^{b} is a single bond or a divalent linking group.

The definition of the divalent linking group is the same as the definition described above with respect to Q^{a}.

However, when k11 is 1 and k12 is 0 in Formula (3), and each of Q^{a} and X³¹ is a single bond, the terminal of Q^{b} on the side bonded to Ak¹ is not an alkylene group.

In other cases, the terminal of Q^{b} may be an alkylene group.

Above all, Q^{b} is preferably an alkylene group which may have an ether oxygen atom. The number of carbon atoms in the alkylene group is preferably from 1 to 30, more preferably from 1 to 20, still more preferably from 2 to 20, and may be from 2 to 10, from 2 to 6, or from 2 to 5. Examples thereof include 2, 3, 8, 9, and 11. The number of carbon atoms may be from 1 to 10.

In Formula (3-1A), R³¹ is a hydrogen atom, a hydroxy group, or an alkyl group.

The number of carbon atoms in the alkyl group is preferably from 1 to 5, more preferably from 1 to 3, and still more preferably 1.
When X³¹ is a single bond or an alkylene group, h is 1, and i is 0,
when X³¹ is a nitrogen atom, h is an integer from 1 to 2, i is an integer from 0 to 1, and h+i=2 is satisfied,
when X³¹ is a carbon atom or a silicon atom, h is an integer from 1 to 3, i is an integer from 0 to 2, and h+i=3 is satisfied,
When X³¹ is a divalent to octavalent organopolysiloxane residue, h is an integer from 1 to 7, i is an integer from 0 to 6, and h+i=1 to 7 is satisfied.
When X³¹ is a group having a (h+i+1)-valent ring, h is an integer from 1 to 7, i is an integer from 0 to 6, and h+i=1 to 7 is satisfied.
When there are two or more (-Q^{b}-Si(R)ₙL₃₋ₙ)s, the two or more (-Q^{b}-Si(R)ₙL₃₋ₙ)s may be identical or different. When there are two or more R³¹s, the two or more (—R³¹)s may be identical or different.

Above all, i is preferably 0 from the viewpoint of improving the wear resistance of the surface treatment layer.

In Formula (3-1A), when Q^{a}, X³¹, and Q^{b} are single bonds, at least one of k11 or k12 in Formula (3) is 1, and [Si(R²)ₙL₃₋ₙ] is directly bonded to Ak¹ or Ak².

In Formula (3-1B), Q^{C} is a single bond or a divalent linking group.

However, when k11 is 1 and k12 is 0 in Formula (3), the terminal of Q^{c} on the side bonded to Ak¹ is not an alkylene group.

The definition of the divalent linking group is the same as the definition described above with respect to Q^{a}.

In Formula (3-1B), R³² is a hydrogen atom or an alkyl group having from 1 to 10 carbon atoms, and is preferably a hydrogen atom from the viewpoint that the compound is easily produced.

The alkyl group is preferably a methyl group.

In Formula (3-1B), Q^{d} is a single bond or an alkylene group. The number of carbon atoms in the alkylene group is preferably from 1 to 10, and more preferably from 1 to 6. Q^{d} is preferably a single bond or CH₂— from the viewpoint that the compound is easily produced.

In Formula (3-1B), R³³ is a hydrogen atom or a halogen atom, and is preferably a hydrogen atom from the viewpoint that the compound is easily produced.

y is an integer from 1 to 10, preferably an integer from 1 to 6.

Two or more [CH₂C(R³²)(-Q^{d}-Si(R²)ₙL₃₋ₙ)]s may be identical or different.

The group (3-1A) is preferably groups (3-1A-1) to (3-1A-7).

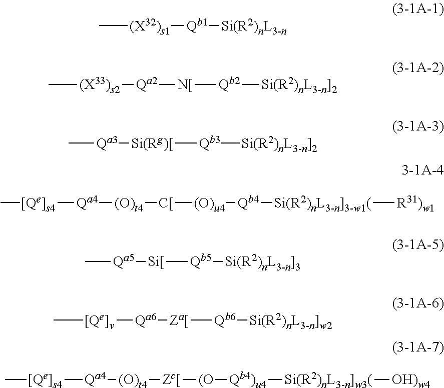

In Formula (3-1A-1) to Formula (3-1A-7), the definitions of R², L, and n are as described above.

However, when k11 is 1 and k12 is 0 in Formula (3), the terminals of the groups (3-1A-1) to (3-1A-7) on the side bonded to Ak¹ are not an alkylene group.

When both k11 and k12 in Formula (3) are 0, the terminals of the groups (3-1A-1) to (3-1A-7) on the side bonded to Si(R¹)₂ are not a divalent linear organopolysiloxane residue.

Above all, the group (3-1A) is preferably a group (3-1A-2) and a group (3-1A-4), and more preferably a group (3-1A-4).

In the group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d}— (but N in the formula is bonded to Q^{b1}).

The definition of R^{d} is as described above.

s¹ is 0 or 1.

In particular, when k11 is 1 and k12 is 0 in Formula (3), X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—. X³² is more preferably —O—, —S—, —N(R^{d})—, —C(O)—, —C(O)S—, —N(R^{d})C(O)N(R^{d})—, —OC(O)N(R^{d})—, or —C(O)N(R^{d})—. X³² is still more preferably —C(O)O— or —C(O)N(R^{d})—.

When both k11 and k12 in Formula (3) are 0, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, and is more preferably —O—.

When k12 in Formula (3) is 1, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—, —S—, —N(R^{d})—, —C(O)O—, —C(O)S—, —N(R^{d})C(O)N(R^{d})—, —OC(O)N(R^{d})—, or —C(O)N(R^{d})—, and still more preferably —C(O)O— or —C(O)N(R^{d})—.

Q^{b1} is a single bond or an alkylene group. The alkylene group may have —O—, a silphenylene backbone group, or a dialkylsilylene group. The alkylene group may have a plurality of groups selected from the group consisting of —O—, a silphenylene backbone group, a divalent organopolysiloxane residue, and a dialkylsilylene group.

When the alkylene group has —O—, a silphenylene backbone group, a divalent organopolysiloxane residue, or a dialkylsilylene group, it is preferable to have such a group between carbon atoms.

The number of carbon atoms in the alkylene group represented by Q^{b1} is preferably from 1 to 30, more preferably from 1 to 20, still more preferably from 2 to 20, and particularly preferably from 2 to 6. The number of carbon atoms may be from 1 to 10.

In particular, when k11 is 1 and k12 is 0 in Formula (3), it is preferable that s1 is 0 and Q^{b1} is a single bond, or s1 is 1 and Q^{b1} is an alkylene group having from 2 to 6 carbon atoms.

When both k11 and k12 in Formula (3) are 0, it is preferable that s1 is 1 and Q^{b1} is an alkylene group having from 2 to 6 carbon atoms.

In particular, when k12 in Formula (3) is 1, it is preferable that s1 is 0 and Q^{b1} is a single bond, or s1 is 1 and Q^{b1} is an alkylene group having from 2 to 6 carbon atoms.

Specific examples of the group (3-1A-1) include the following groups. In the following formulae, * represents a bonding site to an adjacent atom.

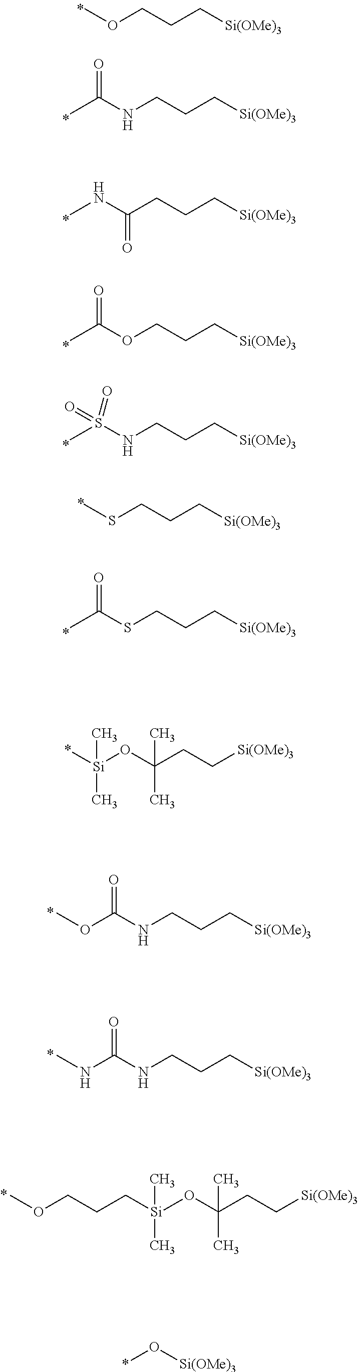

In the group (3-1A-2), X³³ is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

The definition of R^{d} is as described above.

s2 is 0 or 1. s2 is preferably 0 from the viewpoint that the compound is easily produced.

In particular, when k11 in Formula (3) is 1 and k12 is 0, or when both k11 and k12 are 0, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

When k12 in Formula (3) is 1, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

Q^{a2} is a single bond, an alkylene group, —C(O)—, or a group having an ether oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms in an alkylene group having 2 or more carbon atoms.

The number of carbon atoms in the alkylene group represented by Q^{a2} is preferably from 1 to 20, more preferably from 1 to 10, still more preferably from 1 to 6, and particularly preferably from 1 to 3.

The number of carbon atoms in the group having an ether oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms in an alkylene group having 2 or more carbon atoms represented by Q^{a2} is preferably from 2 to 10, more preferably from 2 to 6.

Q^{a2} is preferably —C(O)— or a single bond, and more preferably —C(O)— from the viewpoint that the compound is easily produced.

Q^{b2} is an alkylene group or a group having a divalent organopolysiloxane residue, an ether oxygen atom, or —NH— between carbon atoms in an alkylene group having 2 or more carbon atoms.

The number of carbon atoms in the alkylene group represented by Q^{b2} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having a divalent organopolysiloxane residue, an ether oxygen atom, or —NH— between carbon atoms in an alkylene group having 2 or more carbon atoms represented by Q^{b2} is preferably from 2 to 10, more preferably from 2 to 6.

From the viewpoint that the compound is easily produced, Q^{b2} is preferably —CH₂CH₂CH₂— or —CH₂CH₂OCH₂CH₂CH₂— (provided that the right side is bonded to Si).

Two [-Q^{b2}-Si(R²)ₙL₃₋ₙ]s may be identical or different.

Specific examples of the group (3-1A-2) include the following groups. In the following formulae, * represents a bonding site to an adjacent atom. In the formulae, α in (CH₂)_{α} bonded to a reactive silyl group is an integer representing the number of methylene groups, and is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10. The plurality of as included in the same compound may be identical or different, but is preferably identical. For example, the plurality of as included in the same compound are all 2, 3, 8, 9, or 11. The same applies hereinafter.

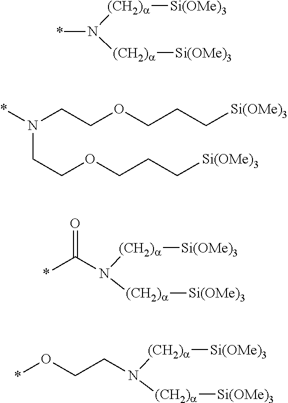

In the group (3-1A-3), Q^{a3} is a single bond or an alkylene group which may have an ether oxygen atom. Q^{a3} is preferably a single bond from the viewpoint that the compound is easily produced.

The number of carbon atoms in the alkylene group which may have an ether oxygen atom is preferably from 1 to 10, and particularly preferably from 2 to 6.

R⁹ is a hydrogen atom, a hydroxy group, or an alkyl group.

R⁹ is preferably a hydrogen atom or an alkyl group from the viewpoint that the compound is easily produced. The number of carbon atoms in the alkyl group is preferably from 1 to 10, more preferably from 1 to 4, and a methyl group is still more preferable.

Q^{b3} is an alkylene group or a group having an ether oxygen atom or a divalent organopolysiloxane residue between carbon atoms in an alkylene group having 2 or more carbon atoms.

The number of carbon atoms in the alkylene group represented by Q^{b3} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organopolysiloxane residue between carbon atoms in an alkylene group having 2 or more carbon atoms represented by Q^{b3} is preferably from 2 to 20, more preferably from 2 to 10, still more preferably from 2 to 6.

Q^{b3} is preferably —CH₂CH₂—, —CH₂CH₂CH₂—, or —CH₂CH₂CH₂CH₂CH₂CH₂CH₂CH₂— from the viewpoint that the compound is easily produced.

Two [-Q^{b3}-Si(R²)ₙL₃₋ₙ]s may be identical or different.

Specific examples of the group (3-1A-3) include the following groups. In the following formulae, * represents a bonding site to an adjacent atom.

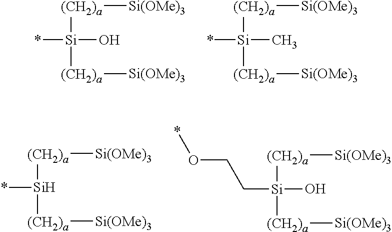

In the group (3-1A-4), Q^{e} is —C(O)O—, —SO₂N(R^{d})—, —N(R^{d})SO₂—, —N(R^{d})C(O)—, or —C(O)N(R^{d})—.

The definition of R³¹ is as described above. When w1 is 1 or 2, R³¹ is preferably a hydrogen atom.

s4 is 0 or 1.

Q^{a4} is a single bond or an alkylene group which may have an ether oxygen atom.

The number of carbon atoms in the alkylene group which may have an ether oxygen atom is preferably from 1 to 20, more preferably from 1 to 10, still more preferably from 1 to 6, and particularly preferably from 1 to 3.

t4 is 0 or 1 (0 when Q^{a4} is a single bond).

From the viewpoint that the compound is easily produced, -Q^{a4}-(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— (provided that the left side is bonded to (XO)ₘ) when s4 is 0, and a single bond, —CH₂—, or —CH₂CH₂— when s4 is 1.

Q^{b4} is an alkylene group, and the alkylene group may have —O—, —C(O)N(R^{d}— (the definition of R^{d} is as described above), a silphenylene backbone group, a divalent organopolysiloxane residue, or a dialkylsilylene group.

When the alkylene group has —O— or a silphenylene backbone group, it is preferable to have —O— or a silphenylene backbone group between carbon atoms. When the alkylene group has —C(O)N(R^{d})—, a dialkylsilylene group, or a divalent organopolysiloxane residue, it is preferable to have such a group between carbon atoms or at a terminal on the side bonded to (O)ᵤ₄.

The number of carbon atoms in the alkylene group represented by Q^{b4} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

u4 is 0 or 1.

From the viewpoint that the compound is easily produced, —(O)ᵤ₄-Q^{b4}- is preferably —CH₂CH₂—, —CH₂CH₂CH₂—, —CH₂CH₂CH₂CH₂CH₂CH₂CH₂CH₂CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂— (provided that the right side is bonded to Si).

w1 is an integer from 0 to 2, preferably 0 or 1, and particularly preferably 0.

When there are two or more [—(O)ᵤ₄-Q^{b4}-Si(R²)ₙL₃₋ₙ]s, the two or more [—(O)ᵤ₄-Q^{b4}-Si(R²)ₙL₃₋ₙ]s may be identical or different.

When there are two or more R³¹s, the two or more (—R³¹)s may be identical or different.

Specific examples of the group (3-1A-4) include the following groups. In the following formulae, * represents a bonding site to an adjacent atom.

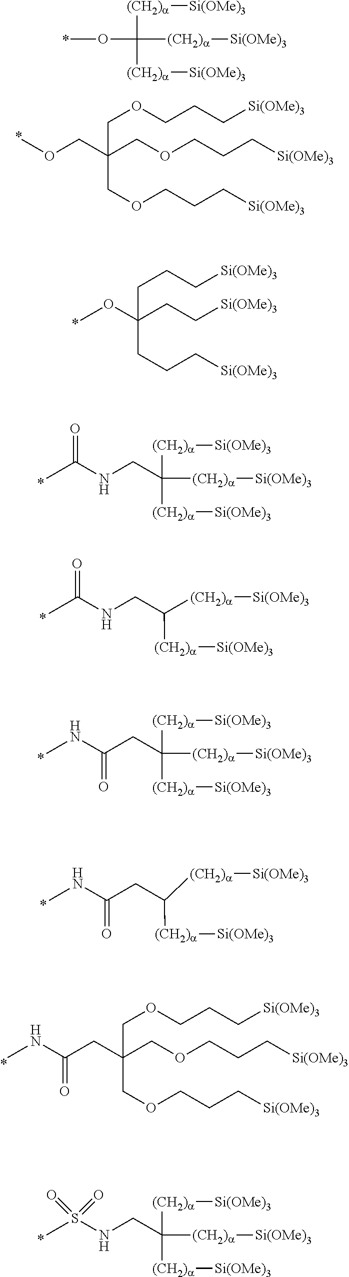

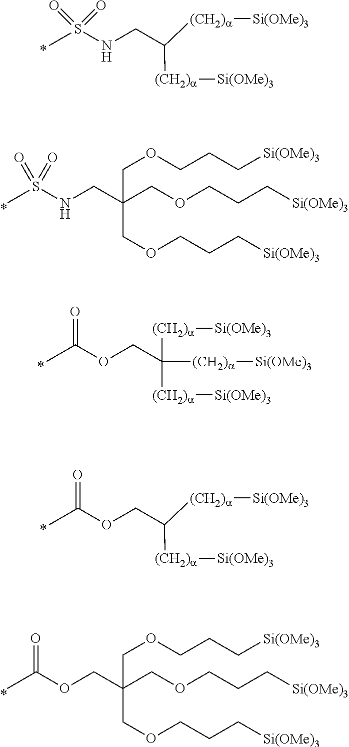

In the group (3-1A-5), Q^{a5} is an alkylene group which may have an ether oxygen atom.

The number of carbon atoms in the alkylene group which may have an ether oxygen atom is preferably from 1 to 10, and particularly preferably from 2 to 6.

From the viewpoint that the compound is easily produced, Q^{a}s is preferably —OCH₂CH₂CH₂—, —OCH₂CH₂OCH₂CH₂CH₂—, —CH₂CH₂—, or —CH₂CH₂CH₂— (provided that the right side is bonded to Si).

Q^{b5} is an alkylene group or a group having an ether oxygen atom or a divalent organopolysiloxane residue between carbon atoms in an alkylene group having 2 or more carbon atoms.

The number of carbon atoms in the alkylene group represented by Q^{b5} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organopolysiloxane residue between carbon atoms in an alkylene group having 2 or more carbon atoms represented by Q^{b5} is preferably from 2 to 20, more preferably from 2 to 10, still more preferably from 2 to 6.

From the viewpoint that the compound is easily produced, Q^{b5} is preferably —CH₂CH₂CH₂— or —CH₂CH₂OCH₂CH₂CH₂— (provided that the right side is bonded to Si(R²)ₙL₃₋ₙ).

Three [-Q^{b5}-Si(R²)ₙL₃₋ₙ]s may be identical or different.

Specific examples of the group (3-1A-5) include the following groups. In the following formulae, * represents a bonding site to an adjacent atom.

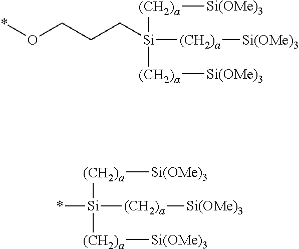

The definition of Q^{e} in the group (3-1A-6) is as defined with respect to the group (3-1A-4) above.

v is 0 or 1.

Q^{a6} is an alkylene group which may have an ether oxygen atom.

The number of carbon atoms in the alkylene group which may have an ether oxygen atom is preferably from 1 to 10, and particularly preferably from 2 to 6.

From the viewpoint that the compound is easily produced, Q^{a6} is preferably —CH₂OCH₂CH₂CH₂—, —CH₂OCH₂CH₂OCH₂CH₂CH₂—, —CH₂CH₂—, or —CH₂CH₂CH₂— (provided that the right side is bonded to Z^{a}).

Z^{a} is a (w2+1)-valent organopolysiloxane residue or a group having a valence of (w2+1) and having an alkylene group between an organopolysiloxane residue and an organopolysiloxane residue.

w2 is an integer from 2 to 7.

Examples of the (w2+1)-valent organopolysiloxane residue and the group having a valence of (w2+1) and having an alkylene group between an organopolysiloxane residue and an organopolysiloxane residue include the following groups. However, R^{a} in the following formulae is as described above. * indicates a bonding site.

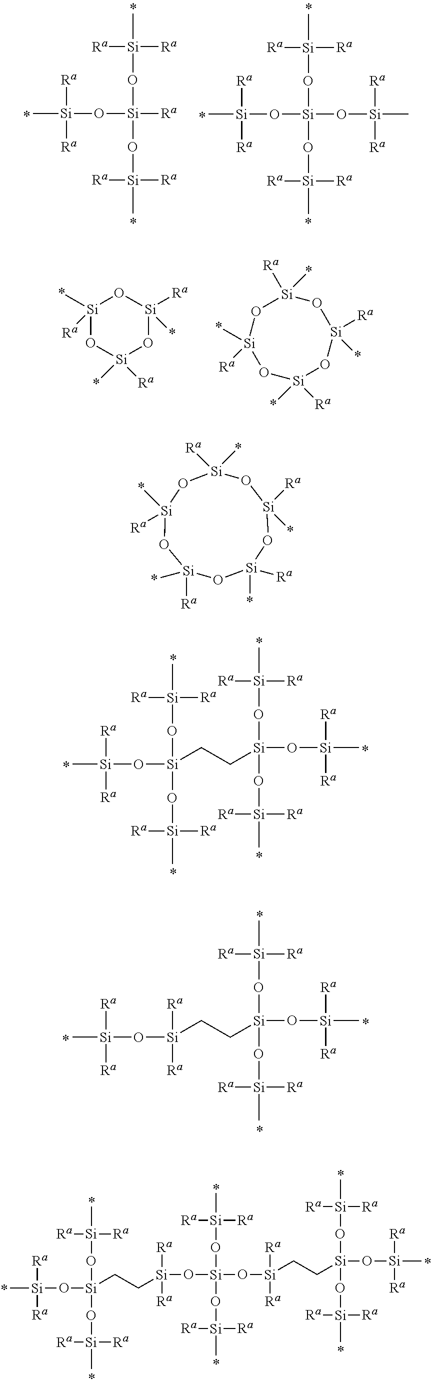

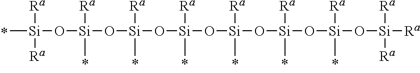

Q^{b6} is an alkylene group or a group having an ether oxygen atom or a divalent organopolysiloxane residue between carbon atoms in an alkylene group having 2 or more carbon atoms.

The number of carbon atoms in the alkylene group represented by Q^{b6} is preferably from 1 to 30, more preferably from 1 to 20, still more preferably from 2 to 20, and may be from 2 to 10, or from 2 to 6. Examples thereof include 2, 3, 8, 9, and 11. The number of carbon atoms may be from 1 to 10.

The number of carbon atoms in the group having an ether oxygen atom or a divalent organopolysiloxane residue between carbon atoms in an alkylene group having 2 or more carbon atoms represented by Q^{b6} is preferably from 2 to 20, more preferably from 2 to 10, still more preferably from 2 to 6.

Q^{b6} is preferably —CH₂CH₂— or —CH₂CH₂CH₂— from the viewpoint that the compound is easily produced.

The w2 number of [-Q^{b6}-Si(R²)ₙL₃₋ₙ]s may be identical or different.

Specific examples of the group (3-1A-6) include the following groups. In the following formulae, * represents a bonding site to an adjacent atom.

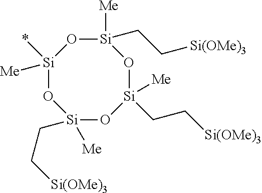

In the group (3-1A-7), Z° is a (w3+w4+1)-valent hydrocarbon group.

w3 is an integer of 4 or more.

w4 is an integer of 0 or more.

The definitions and preferred ranges of Q^{e}, s4, Q^{a4}, t4, Q^{b4}, and u4 are the same as the definitions of the respective symbols in the group (3-1A-4).

Z^{c} may be formed of a hydrocarbon chain, may have an ether oxygen atom between carbon atoms in a hydrocarbon chain, and is preferably formed of a hydrocarbon chain.

The valence of Z^{c} is preferably from 5 to 20, more preferably from 5 to 10, still more preferably from 5 to 8, and particularly preferably from 5 to 6.

The number of carbon atoms in Z^{c} is preferably from 3 to 50, more preferably from 4 to 40, and still more preferably from 5 to 30.

w3 is preferably from 4 to 20, more preferably from 4 to 16, still more preferably from 4 to 8, and particularly preferably from 4 to 5.

w4 is preferably from 0 to 10, more preferably 0 to 8, still more preferably from 0 to 6, particularly preferably from 0 to 3, and most preferably from 0 to 1.

When there are two or more [—(O-Q^{b4})ᵤ₄-Si(R²)ₙL₃₋ₙ]s, the two or more [—(O-Q^{b4})ᵤ₄-Si(R²)ₙL₃₋ₙ]s may be identical or different.

Specific examples of the group (3-1A-7) include the following groups. In the following formulae, * represents a bonding site to an adjacent atom.

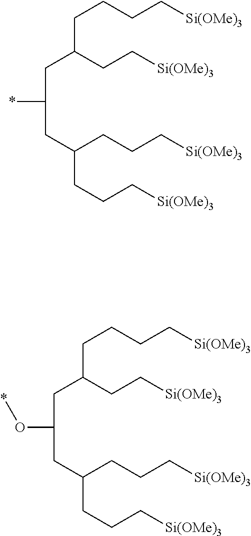

A¹¹ in Formula (3) may be a group (g2-1) (provided that d1+d3=1 and d2+d4=q), a group (g2-2) (provided that e1=1 and e2=q), a group (g2-3) (provided that q=2), a group (g2-4) (provided that h1=1 and h2=q), a group (g2-5) (provided that i1=1 and i2=q), a group (g2-6) (provided that q=1), or a group (g2-7) (provided that i3=q).

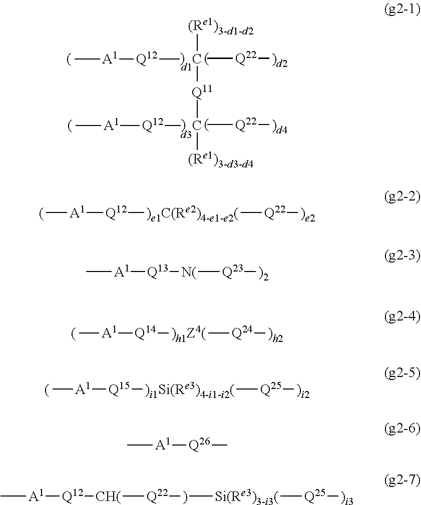

However, in Formulae (g2-1) to (g2-7), the A¹ side is bonded to the (Ak²)ₖ₁₂ side of Formula (3), and the Q²², Q²³, Q²⁴, Q²⁵, or Q²⁶ side is bonded to [—Si(R²)ₙL₃₋ₙ].

When k11 is 1 and k12 is 0 in Formula (3), the terminal of A¹ on the side bonded to the (Ak²)ₖ₁₂ side is not an alkylene group.

A¹ is a single bond, —C(O)NR⁶—, —C(O)—, —OC(O)O—, —NHC(O)O—, —NHC(O)NR⁶—, —O—, or SO₂NR⁶—.

Q¹¹ is a single bond, —O—, an alkylene group, or a group having —C(O)NR⁶—, —C(O)—, —NR⁶—, or O— between carbon atoms in an alkylene group having 2 or more carbon atoms.

Q¹² is a single bond, an alkylene group, or a group having —C(O)NR⁶—, —C(O)—, —NR⁶—, or O— between carbon atoms in an alkylene group having 2 or more carbon atoms, and when A¹¹ has 2 or more Q¹²s, the 2 or more Q¹²s may be identical or different.

Q¹³ is a single bond (provided that A¹ is —C(O)—), an alkylene group, a group having —C(O)NR⁶—, —C(O)—, —NR—, or O— between carbon atoms in an alkylene group having 2 or more carbon atoms, or a group having —C(O)— at the N-side terminal of an alkylene group.

Q¹⁴ is Q¹² when the atom in Z⁴ to which Q¹⁴ is bonded is a carbon atom, is Q¹³ when the atom in Z⁴ to which Q¹⁴ is bonded is a nitrogen atom, and when A¹¹ has 2 or more of Q¹⁴s, the 2 or more Q¹⁴s may be identical or different.

Q¹⁵ is an alkylene group, or a group having —C(O)NR⁶—, —C(O)—, —NR⁶—, or O— between carbon atoms in an alkylene group having 2 or more carbon atoms, and when A¹¹ has 2 or more Q¹⁵s, the 2 or more Q¹⁵s may be identical or different.

Q²² is an alkylene group, a group having —C(O)NR⁶—, —C(O)—, —NR⁶—, or O— between carbon atoms in an alkylene group having 2 or more carbon atoms, a group having —C(O)NR⁶—, —C(O)—, —NR⁶—, or O— at a terminal of the alkylene group on the side not connected to Si, or a group having —C(O)NR⁶—, —C(O)—, —NR⁶—, or O— between carbon atoms in an alkylene group having 2 or more carbon atoms and having —C(O)NR⁶—, —C(O)—, —NR⁶—, or O— at a terminal on the side not connected to Si, and when A¹¹ has 2 or more Q²²s, the 2 or more Q²²s may be identical or different

Q²³ is an alkylene group, or a group having —C(O)NR⁶—, —C(O)—, —NR⁶—, or O— between carbon atoms in an alkylene group having 2 or more carbon atoms, and two Q²³s may be identical or different.

Q²⁴ is Q²² when the atom in Z⁴ to which Q²⁴ is bonded is a carbon atom, is Q²³ when the atom in Z⁴ to which Q²⁴ is bonded is a nitrogen atom, and when A¹¹ has 2 or more of Q²⁴s, the 2 or more of Q²⁴s may be identical or different.

Q²⁵ is an alkylene group, or a group having —C(O)NR⁶—, —C(O)—, —NR⁶—, or O— between carbon atoms in an alkylene group having 2 or more carbon atoms, and when A¹¹ has 2 or more Q²⁵s, the 2 or more Q²⁵s may be identical or different.

Q²⁶ is an alkylene group, or a group having —C(O)NR⁶—, —C(O)—, —NR⁶—, or O— between carbon atoms in an alkylene group having 2 or more carbon atoms.

When Q²², Q²³, Q²⁴, Q²⁵, and Q²⁶ are alkylene groups, the number of carbon atoms is preferably from 1 to 20, more preferably from 1 to 10, and still more preferably from 1 to 6.

Z⁴ is a group having a h1+h2-valent ring structure having a carbon atom or a nitrogen atom to which Q¹⁴ is directly bonded and having a carbon atom or a nitrogen atom to which Q²⁴ is directly bonded.

R^{e1} is a hydrogen atom or an alkyl group, and when A¹¹ has 2 or more R^{e1}s, the 2 or more R^{e1}s may be identical or different.

R^{e2} is a hydrogen atom, a hydroxy group, an alkyl group, or an acyloxy group.

R^{e3} is an alkyl group. R⁶ is a hydrogen atom, an alkyl group having from 1 to 6 carbon atoms, or a phenyl group.

d1 is an integer from 0 to 1.

d2 is an integer from 0 to 3, and is preferably 1 or 2.

d1+d2 is an integer from 1 to 3.

d3 is an integer from 0 to 1.

d4 is an integer from 0 to 3, and is preferably 2 or 3.

d3+d4 is an integer from 1 to 3.

d1+d3 is 1.

d2+d4 is an integer from 1 to 5, and is preferably 4 or 5.

e1+e2 is 3 or 4.

e1 is 1.

e2 is an integer from 1 to 3, and is preferably 2 or 3.

h1 is 1.

h2 is an integer of 1 or more, and is preferably 2 or 3.

i1+i2 is 3 or 4.

i1 is 1.

i2 is an integer from 1 to 3, and is preferably 2 or 3.

i3 is 2 or 3.

The number of carbon atoms in the alkylene group of Q¹¹, Q¹², Q¹³, Q¹⁴, Q¹⁵, Q²², Q²³, Q²⁴, Q²⁵, and Q²⁶ is preferably from 1 to 30, more preferably from 1 to 20, still more preferably from 2 to 20, and may be from 2 to 10, or from 2 to 6 from the viewpoint that the compound is easily produced and the surface treatment layer has more excellent wear resistance. Examples thereof include 2, 3, 8, 9, and 11. The number of carbon atoms may be from 1 to 10, or from 1 to 6, or from 1 to 4. However, the lower limit value of the number of carbon atoms in the alkylene group in the case of having a specific bond between carbon atoms is 2.

Examples of the ring structure in Z⁴ include the ring structures described above, and preferred forms are also the same. Since Q¹⁴ and Q²⁴ are directly bonded to the ring structure in Z⁴, it does not occur, for example, that an alkylene group is linked to the ring structure and Q¹⁴ and Q²⁴ are linked to the alkylene group.

The number of carbon atoms in the alkyl group of R^{e1}, R^{e2}, or R^{e3} is preferably from 1 to 6, more preferably from 1 to 3, and particularly preferably from 1 to 2 from the viewpoint that the compound is easily produced.

The number of carbon atoms in the alkyl group moiety of the acyloxy group of R^{e2} is preferably from 1 to 6, more preferably from 1 to 3, and particularly preferably from 1 to 2 from the viewpoint that the compound is easily produced.

h1 is preferably from 1 to 6, more preferably from 1 to 4, still more preferably 1 or 2, and particularly preferably 1 from the viewpoint that the compound is easily produced and the surface treatment layer has more excellent wear resistance.

h2 is preferably from 2 to 6, more preferably from 2 to 4, and particularly preferably 2 or 3 from the viewpoint that the compound is easily produced and the surface treatment layer has more excellent wear resistance.

Examples of other forms of A¹¹ include a group (g2-8) (provided that d1+d3=1 and d2×k3+d4×k3=q), a group (g2-9) (provided that e1=1 and e2×k3=q), a group (g2-10) (provided that 2×k3=q), a group (g2-11) (provided that h1=1 and h2×k3=q), a group (g2-12) (provided that i1=1 and i2×k3=q), a group (g2-13) (provided that k3=q), or a group (g2-14) (provided that i3×k3=q).

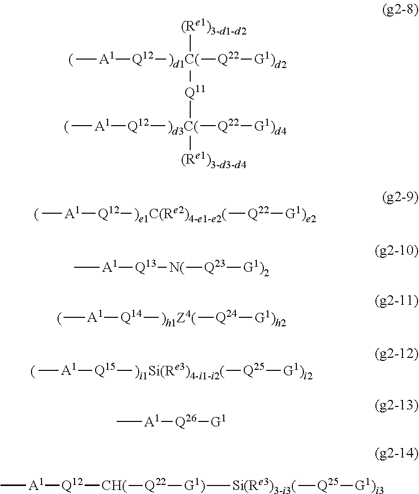

However, in Formulae (g2-8) to (g2-14), the A¹ side is bonded to the (Ak²)ₖ₁₂ side of Formula (3), and the G¹ side is bonded to [—Si(R²)ₙL₃₋ₙ].

When k11 is 1 and k12 is 0 in Formula (3), the terminal of A¹ on the side bonded to the (Ak²)ₖ₁₂ side is not an alkylene group.

G¹ is the following group (g3), and 2 or more G¹s of A¹¹ may be identical or different. The symbols other than G¹ are the same as the symbols in Formulae (g2-1) to (g2-7).

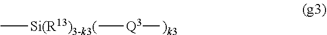

However, in the group (g3), the Si side is connected to Q²², Q²³, Q²⁴, Q²⁵, and Q²⁶, and the Q³ side is connected to [—Si(R²)ₙL₃₋ₙ]. R¹³ is an alkyl group. Q³ is an alkylene group, a group having —C(O)NR⁶—, —C(O)—, —NR⁶—, or —O— between carbon atoms in an alkylene group having 2 or more carbon atoms, or (OSi(R⁹)₂)ₚ—O—, and 2 or more Q³s may be identical or different. k3 is 2 or 3. R⁶ is a hydrogen atom, an alkyl group having from 1 to 6 carbon atoms, or a phenyl group. R⁹ is an alkyl group, a phenyl group, or an alkoxy group, and two R⁹s may be identical or different. p is an integer from 0 to 5, and when p is 2 or more, the 2 or more (OSi(R⁹)₂)s may be identical or different.

The number of carbon atoms in the alkylene group of Q³ is preferably from 1 to 30, more preferably from 1 to 20, still more preferably from 2 to 20, and may be from 2 to 10, or from 2 to 6 from the viewpoint that the compound is easily produced and the surface treatment layer has more excellent wear resistance. Examples thereof include 2, 3, 8, 9, and 11. The number of carbon atoms may be from 1 to 10, or from 1 to 6, or from 1 to 4. However, the lower limit value of the number of carbon atoms in the alkylene group in the case of having a specific bond between carbon atoms is 2.

The number of carbon atoms in the alkyl group of R¹³ is preferably from 1 to 6, more preferably from 1 to 3, and still more preferably from 1 to 2 from the viewpoint that the compound is easily produced.

The number of carbon atoms in the alkyl group of R⁹ is preferably from 1 to 6, more preferably from 1 to 3, and still more preferably from 1 to 2 from the viewpoint that the compound is easily produced.

The number of carbon atoms in the alkoxy group of R⁹ is preferably from 1 to 6, more preferably from 1 to 3, and particularly preferably from 1 to 2 from the viewpoint that the compound has excellent storage stability.

p is preferably 0 or 1.

The group A in the first compound and the group A in the second compound may be the same as or different from each other. The group A in the first compound and the group A in the second compound are preferably the same from the viewpoint of improving the balance among an antifouling property, fingerprint removability, and slipperiness. When the first composition contains the third compound, the group A in the first compound, the group A in the second compound, and the group A in the third compound may all be the same as each other, only two of them may be the same as each other, or all may be different from each other. The group A in the first compound, the group A in the second compound, and the group A in the third compound are all preferably the same as each other from the viewpoint of improving the balance among an antifouling property, fingerprint removability, and slipperiness.

### SPECIFIC EXAMPLES

Specific examples of the compound (1) include the following compounds. In the following formulae, each m has the same meaning as m in Formula (1). In each of the compounds of Chem. 23 and Chem. 24, as for a moiety related to (Si(R′)₂—O)ₘ in Formula (1), (Si(Me)₂-O) and (Si(R¹)₂—O)<provided that (R¹)₂ is not (Me)₂> and (Si(Me)₂-O)ₘ₋₂ are bonded to form (Si(R′)₂—O)ₘ in Formula (1). In each compound of Chem. 25, as for a moiety related to (Si(R′)₂—O)ₘ in Formula (1), (Si(R′)₂—O)<provided that (R¹)₂ is not (Me)₂> and (Si(Me)₂-O)ₘ₋₁ are bonded to form (Si(R′)₂—O)ₘ in Formula (1).

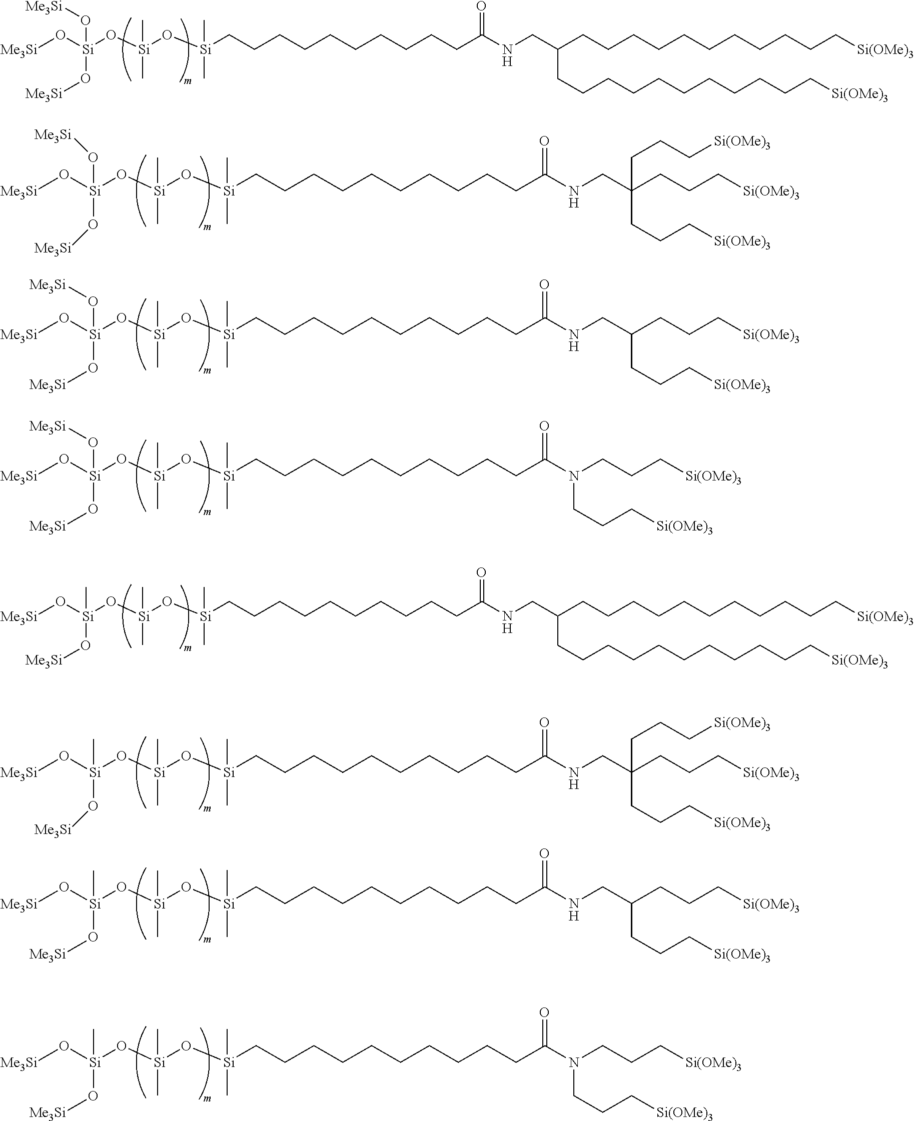

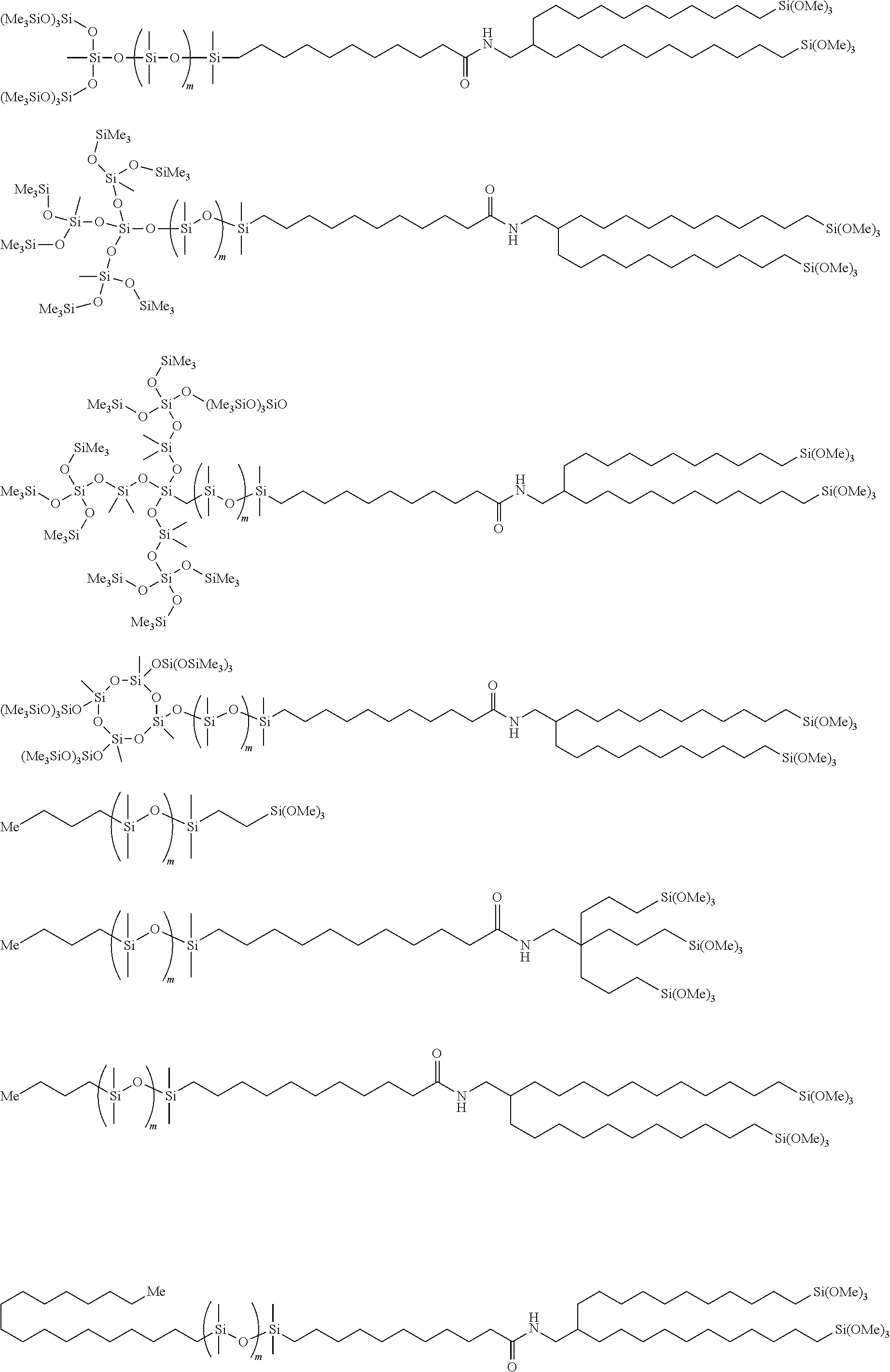

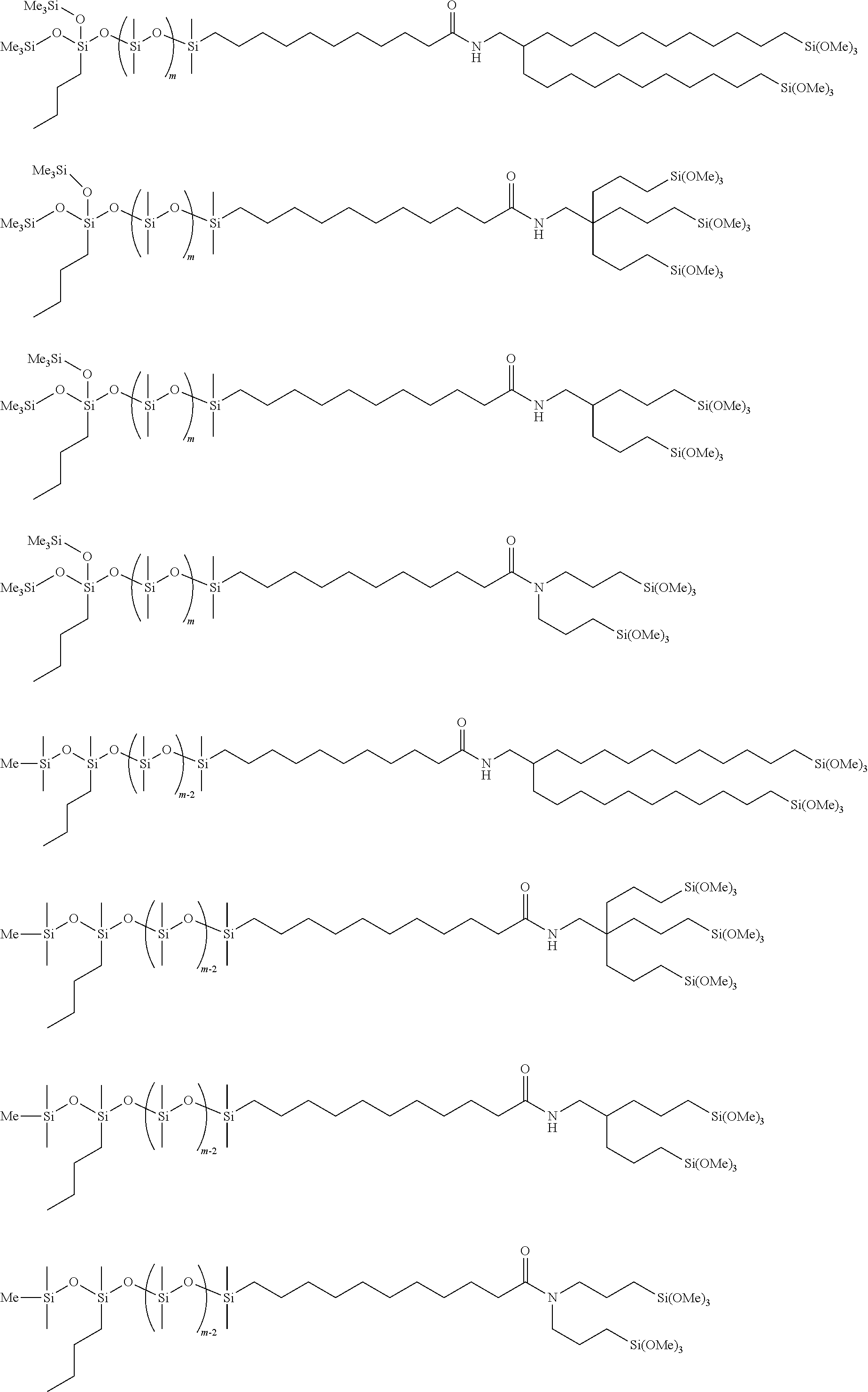

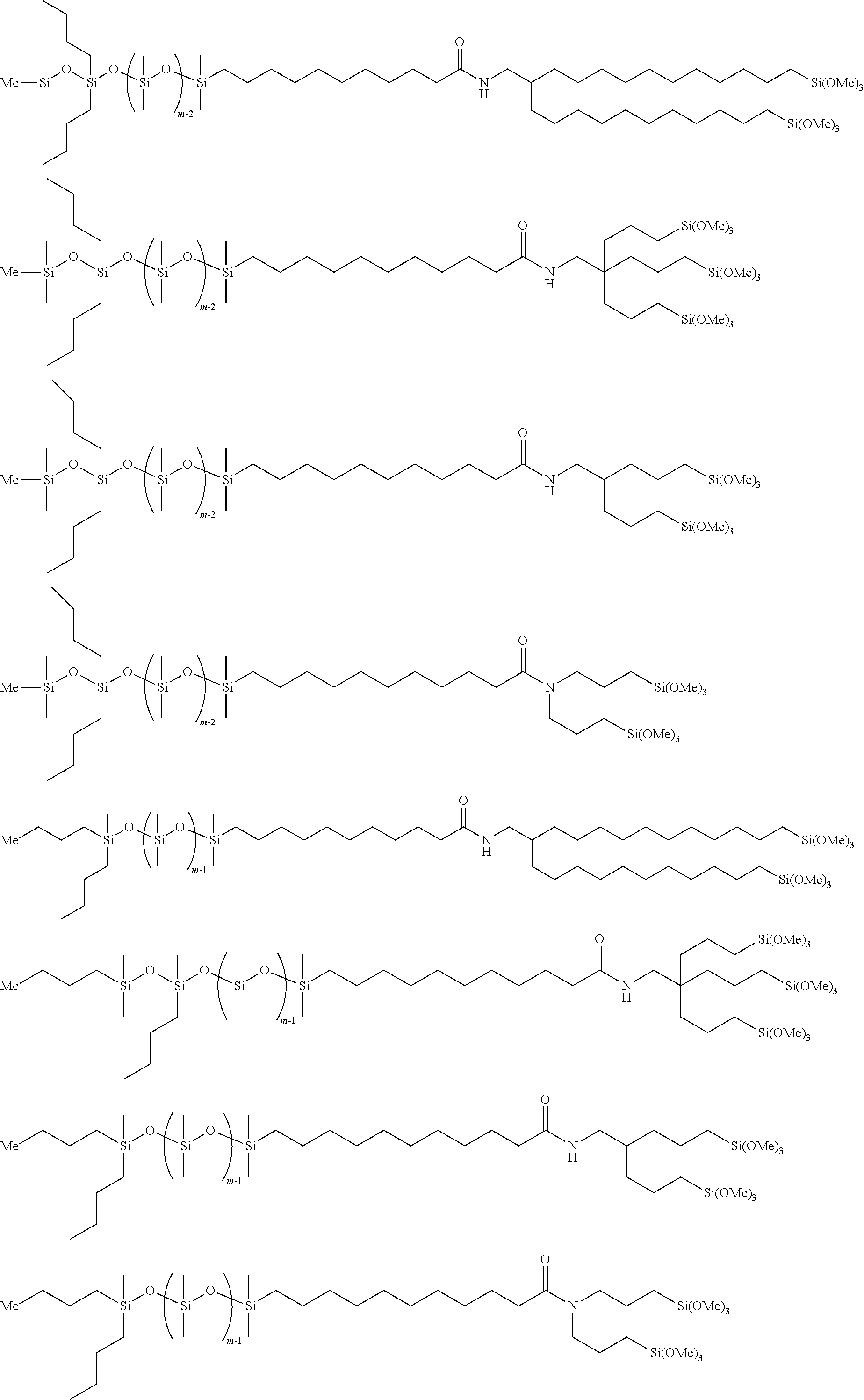

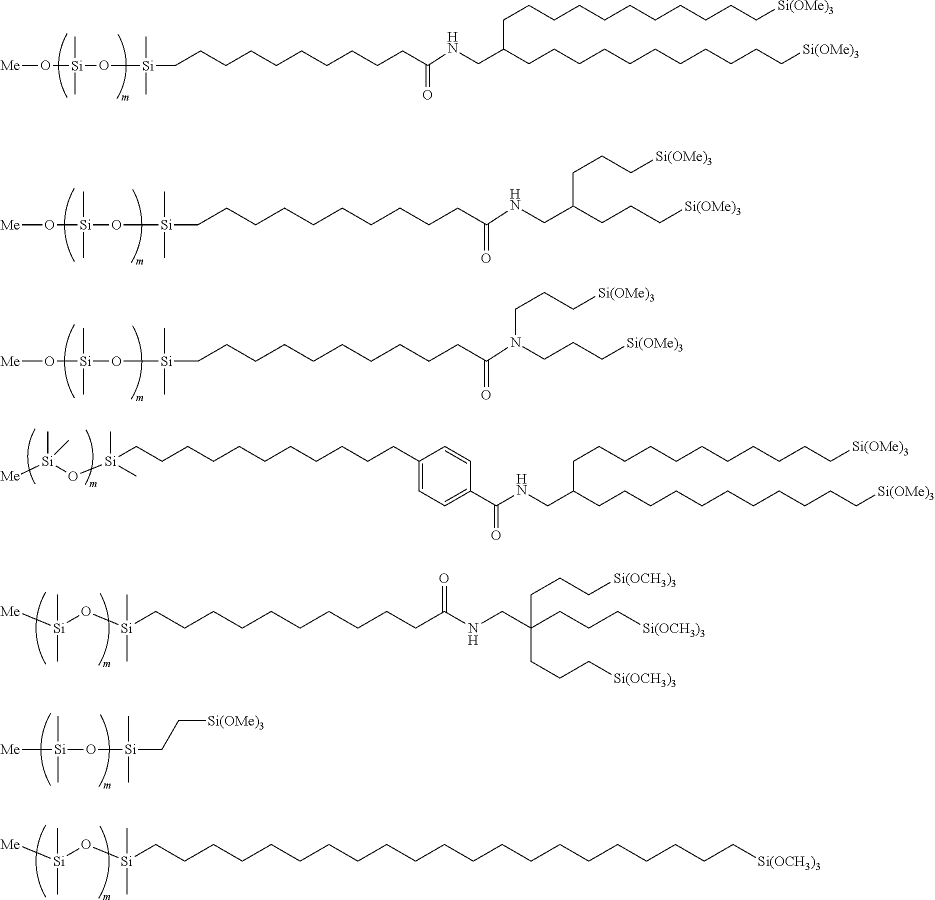

The number average molecular weight (Mn) of the compound (1) is preferably from 500 to 20,000, more preferably from 600 to 18,000, and still more preferably from 700 to 15,000. Here, the number average molecular weight (Mn) of the compound (1) means the total number average molecular weight (Mn) of two or more kinds of compounds (1) contained in the first composition.

When the Mn is 500 or more, the surface treatment layer has more excellent wear resistance. When the Mn is 20,000 or less, the viscosity is easily adjusted within an appropriate range, and the solubility is improved. Therefore, handleability at the time of film formation is excellent.

In the two or more kinds of compounds (1), at least the structures of the groups T need only be different from each other. The structure other than the group T in the first compound and the structure other than the group T in the second compound may be the same as or different from each other. The first compound and the second compound preferably mutually have the same group R¹, preferably mutually have the same group R¹ and group A, and more preferably mutually have the same group R¹, group A, reactive silyl group, and q from the viewpoint of improving the balance among an antifouling property, fingerprint removability, and slipperiness.

When the first composition contains the third compound, the first compound, the second compound, and the third compound need only be different from each other at least in the structure of the group T. The structure other than the group T in the first compound, the structure other than the group T in the second compound, and the structure other than the group T in the third compound may all be the same as each other, only two of them may be the same as each other, or all may be different from each other. The first compound, the second compound, and the third compound preferably all mutually have the same group R¹, preferably all mutually have the same group R¹ and group A, and more preferably all mutually have the same group R¹, group A, reactive silyl group, and q from the viewpoint of improving the balance among an antifouling property, fingerprint removability, and slipperiness.

The first composition may contain impurities such as by-products generated in the production step of the compound (1).

### (Content Amount)

In a case where the first composition contains two or more kinds of compounds (1), when the compound (1) with the highest content amount among the compounds (1) contained in the first composition is defined as a first compound and the compound (1) with the second highest content amount is defined as a second compound, the content percentage of the first compound with respect to all compounds (1) is preferably from 10 to 90 mass %, more preferably from 30 to 90 mass %, and still more preferably from 40 to 80 mass %.

The content percentage of the first compound with respect to the total (100 mass %) of the first compound and the second compound is preferably from 50 to 90 mass %, and more preferably from 50 to 80 mass %.

In a case where the first composition contains three or more kinds of compounds (1), when the compound (1) with the highest content amount among the compounds (1) contained in the first composition is defined as a first compound, the compound (1) with the second highest content amount is defined as a second compound, and the compound (1) with the third highest content amount is defined as a third compound. In this case, the content percentage of the first compound with respect to all compounds (1) is preferably from 10 to 90 mass %, more preferably from 30 to 80 mass %, and still more preferably from 40 to 60 mass %. The content percentage of the second compound with respect to all compounds (1) is preferably 5 mass % or more, more preferably 10 mass % or more, and still more preferably 20 mass % or more. The content percentage of the first compound with respect to the total (100 mass %) of the first compound, the second compound, and the third compound is preferably from 35 to 90 mass %, more preferably from 35 to 80 mass %, and still more preferably from 35 to 60 mass %. The content percentage of the second compound with respect to the total (100 mass %) of the first compound, the second compound, and the third compound is preferably from 5 mass % or more, more preferably 10 mass % or more, and still more preferably 20 mass % or more. The content percentage of the third compound with respect to the total (100 mass %) of the first compound, the second compound, and the third compound is preferably from 5 mass % or more, more preferably 10 mass % or more, and still more preferably 20 mass % or more.

When the first composition contains the first compound in which the group T is a group (2A) or a group (2B) and the second compound in which the group T is a methyl group, a linear alkyl group, or a branched cyclic alkyl group, the content percentage of the first compound with respect to the total (100 mass %) of the first compound and the second compound is preferably from 10 to 90 mass %, more preferably from 30 to 90 mass %, and still more preferably from 40 to 80 mass %.

When the first composition contains the first compound in which the group T is a group (2A) or a group (2B), the second compound in which the group T is a linear alkyl group or a branched cyclic alkyl group, and the third compound in which the group T is a methyl group, the content percentage of the first compound with respect to the total (100 mass %) of the first compound, the second compound, and the third compound is preferably from 10 to 90 mass %, more preferably from 30 to 80 mass %, and still more preferably from 40 to 60 mass %. The content percentage of the second compound with respect to the total (100 mass %) of the first compound, the second compound, and the third compound is preferably from 5 to 85 mass %, more preferably from 10 to 60 mass %, and still more preferably from 20 to 40 mass %. The content percentage of the third compound with respect to the total (100 mass %) of the first compound, the second compound, and the third compound is preferably from 5 to 85 mass %, more preferably from 10 to 60 mass %, and still more preferably from 20 to 40 mass %.

The first composition contains, as the first compound, a compound in which the group T is a group (2A) or a group (2B) in an amount of preferably 10 mass % or more, more preferably 30 mass % or more, still more preferably 40 mass % or more, and particularly preferably 50 mass % or more with respect to all compounds (1), from the viewpoint of improving the balance among an antifouling property, fingerprint removability, and slipperiness.

The first composition contains, as the first compound, a compound in which the group T is the group (2A-1) or the group (2A-2) in an amount of preferably 10 mass % or more, more preferably 30 mass % or more, still more preferably 40 mass % or more, and particularly preferably 50 mass % or more with respect to all compounds (1), from the viewpoint of improving the balance among an antifouling property, fingerprint removability, and slipperiness.

The first composition contains, as the first compound, a compound in which the group T is the group (2A-1-1) or the group (2A-2-1) in an amount of preferably 10 mass % or more, more preferably 30 mass % or more, still more preferably 40 mass % or more, and particularly preferably 50 mass % or more, with respect to all compounds (1), from the viewpoint of improving the balance among an antifouling property, fingerprint removability, and slipperiness.

When the compound (1) with the highest content amount among the compounds (1) contained in the first composition is defined as a first compound and the compound (1) with the second highest content amount is defined as a second compound, the content amount of the second compound with respect to 100 parts by mass of the first compound is preferably from 5 to 100 parts by mass, more preferably from 10 to 100 parts by mass, still more preferably from 12 to 100 parts by mass, particularly preferably from 25 to 100 parts by mass, and most preferably from 33 to 100 parts by mass.

In a case where the first composition contains three or more kinds of compounds (1), when the compound (1) with the highest content amount is defined as a first compound, the compound (1) with the second highest content amount is defined as a second compound, and the compound (1) with the third highest content amount is defined as a third compound, the content amount of the third compound with respect to 100 parts by mass of the first compound is preferably from 5 to 85 parts by mass, more preferably from 12 to 85 parts by mass, and still more preferably from 33 to 85 parts by mass.

The total content amount of two or more kinds of compounds (1) is preferably from 0.001 to 50 mass %, more preferably from 0.01 to 20 mass %, and still more preferably from 0.1 to 10 mass % with respect to the total amount of the first composition. In the case of the first composition used in a wet coating method, the total content amount of the two or more kinds of compounds (1) may be from 0.01 to 10 mass %, from 0.02 to 5 mass %, from 0.03 to 3 mass %, or from 0.05 to 2 mass % with respect to the total amount of the first composition.

### <Compound (A)>

The compound (A) contained in the composition of the disclosure will be described.

### (Group T)

T in Formula (A) is a monovalent group, and specific examples and preferred examples are the same as those of the monovalent group represented by T in Formula (1).

The group T in the first compound and the group T in the second compound may be the same as or different from each other. However, when the group Y¹ in the first compound and the group Y¹ in the second compound are the same, the group T in the first compound and the group T in the second compound are different from each other. On the other hand, when the composition is the second composition, that is, when the group Y¹ in the first compound and the group Y¹ in the second compound are different from each other, the group T in the first compound and the group T in the second compound may be the same or different.

When the composition contains the third compound, the group Tin the third compound and the group T in the first compound may be the same as or different from each other as long as the group Y¹ in the third compound and the group Y¹ in the first compound are different. On the other hand, when the group Y¹ in the third compound and the group Y¹ in the first compound are the same, the group T in the third compound and the group T in the first compound are different from each other. The relationship between the group T in the third compound and the group T in the second compound is also the same as the relationship between the group T in the third compound and the group T in the first compound.

### (Group R¹, Group A, m, and q)

Each R¹ in Formula (A) is independently a monovalent hydrocarbon group, and specific examples and preferred examples are the same as those of the monovalent hydrocarbon group represented by R¹ in Formula (1).

A in Formula (A) is a (q+1)-valent linking group, and specific examples and preferred examples are the same as those of the (q+1)-valent linking group represented by A in Formula (1).

m in Formula (A) is a number of 1 or more, and a preferred range is the same as that of m in Formula (1).

q in Formula (A) is an integer of 1 or more, and a preferred range is the same as that of q in Formula (1).

The group R¹ in the first compound and the group R¹ in the second compound may be the same as or different from each other. The group R¹ in the first compound and the group R¹ in the second compound are preferably the same from the viewpoint of improving the balance among an antifouling property, fingerprint removability, and slipperiness. When the composition contains the third compound, the group R¹ in the first compound, the group R¹ in the second compound, and the group R¹ in the third compound may all be the same as each other, only two of them may be the same as each other, or all may be different from each other. The group R¹ in the first compound, the group R¹ in the second compound, and the group R¹ in the third compound are all preferably the same as each other from the viewpoint of improving the balance among an antifouling property, fingerprint removability, and slipperiness.

The same applies to the group A, m, and q.

### (Group Y¹)

Y¹ in Formula (A) is a monovalent hydrocarbon group or a group represented by Formula (1A).

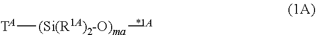

In Formula (1A),
T^{A} is a monovalent group,
each R^{1A} is independently a monovalent hydrocarbon group,
ma is a number of 1 or more, and
*^{1A} is a bonding site to a silicon atom in Formula (A).

Specific examples and preferred examples of the monovalent hydrocarbon group represented by Y¹ in Formula (A) are the same as those of the monovalent hydrocarbon group represented by R¹ in Formula (1).

When Y¹ in Formula (A) is a group (1A), specific examples and preferred examples of the monovalent group represented by T^{A} and the monovalent hydrocarbon group represented by R^{1A} in Formula (1A) are the same as those of the monovalent group represented by T and the monovalent hydrocarbon group represented by R¹ in Formula (1), respectively.

When Y¹ in Formula (A) is a group (1A), the preferred range of ma in Formula (1A) is the same as that of m in Formula (1).

When Y¹ in Formula (A) is a group (1A), T-(Si(R¹)₂—O)ₘ— and Y¹ (that is, the group (1A)) in Formula (A) may be the same as or different from each other. From the viewpoint of ease of availability of the raw material and ease of production of the compound, T-(Si(R¹)₂—O)ₘ— and Y¹ in Formula (A) are preferably the same.

From the viewpoint of obtaining a surface treatment layer having an excellent antifouling property, at least one kind of group Y¹ of the compound (A) contained in the composition is preferably a group (1A).

From the viewpoint of obtaining a surface treatment layer having excellent fingerprint removability, at least one kind of group Y¹ of the compound (A) contained in the composition is preferably a monovalent hydrocarbon group, and more preferably a methyl group.

From the viewpoint of obtaining a surface treatment layer having excellent slipperiness, at least one kind of group Y¹ of the compound (A) contained in the composition is preferably a monovalent hydrocarbon group, and more preferably a methyl group.

Examples of the combination of the group Y¹ of the first compound and the group Y¹ of the second compound include a combination of a group (1A) and a group (1A), a combination of a group (1A) and a monovalent hydrocarbon group, and a combination of a monovalent hydrocarbon group and a monovalent hydrocarbon group. However, when the group T in the first compound and the group T in the second compound are the same, the group Y¹ in the first compound and the group Y¹ in the second compound are different from each other. On the other hand, when the group T in the first compound and the group T in the second compound are different from each other, the group Y¹ in the first compound and the group Y¹ in the second compound may be the same or different.

From the viewpoint of obtaining a surface treatment layer having an antifouling property, fingerprint removability, and slipperiness in a well-balanced manner, it is preferable that the group Y¹ of the first compound is a group (1A) and the group Y¹ of the second compound is a monovalent hydrocarbon group. It is more preferable that the group Y¹ of the first compound is a trimethylsilyloxy group and the group Y¹ of the second compound is a methyl group.

When the composition further contains the third compound, examples of the combination of the group Y¹ of the first compound, the group Y¹ of the second compound, and the group Y¹ of the third compound include a combination of a group (1A), a group (1A), and a group (1A), a combination of a group (1A), a group (1A), and a monovalent hydrocarbon group, a combination of a group (1A), a monovalent hydrocarbon group, and a monovalent hydrocarbon group, and a combination of a monovalent hydrocarbon group, a monovalent hydrocarbon group, and a monovalent hydrocarbon group. However, the first compound and the third compound are different in at least one of the group T or the group Y¹, and the second compound and the third compound are different in at least one of the group T or the group Y¹.

From the viewpoint of obtaining a surface treatment layer having an antifouling property, fingerprint removability, and slipperiness in a well-balanced manner, it is preferable that the group Y¹ of the first compound is a group (1A), the group Y¹ of the second compound is a monovalent hydrocarbon group, and the group Y¹ of the third compound is a monovalent hydrocarbon group. It is more preferable that the group Y¹ of the first compound is a trimethylsilyloxy group, the group Y¹ of the second compound is a methyl group, and the group Y¹ of the third compound is a methyl group.

### (Group Y²)

Each Y² in Formula (A) is independently a group represented by Formula (S1) or Formula (S3).

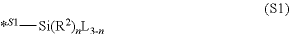

In Formula (S1),
each R² is independently a hydrocarbon group,
each L is independently a hydrolyzable group, a group having a hydrolyzable group, or a hydroxy group,
n is an integer from 0 to 2, and
*^{S1} is a bonding site to a linking group represented by A in Formula (A).

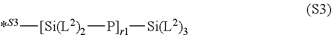

In Formula (S3),
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
*^{S3} is a bonding site to a linking group represented by A in Formula (A).

When there is a plurality of groups (S1) in one molecule, the plurality of groups (S1) may be the same or different from each other. From the viewpoint of ease of availability of the raw material and ease of production of the compound, the plurality of groups (S1) are preferably the same.

Specific examples and preferred examples of R² and L in Formula (S1) are the same as those of R² and L in Formula (1).

The preferred range of n in Formula (S1) is the same as that of n in Formula (1).

Specific examples and preferred examples of the group (S1) are the same as those of the reactive silyl group in Formula (1).

When there is a plurality of groups (S3) in one molecule, the plurality of groups (S3) may be the same or different from each other. From the viewpoint of ease of availability of the raw material and ease of production of the compound, the plurality of groups (S3) are preferably the same.

Each L² is independently a hydrolyzable group, a group having a hydrolyzable group, a hydroxy group, or a hydrocarbon group.

Details of the hydrolyzable group and the group having a hydrolyzable group are as described above.

Above all, the hydrolyzable group or the group having a hydrolyzable group in L² is preferably an alkoxy group having from 1 to 4 carbon atoms, an alkylene oxide-modified alkoxy group, or a halogen atom from the viewpoint of ease of production of the compound. L² is preferably an alkoxy group having from 1 to 4 carbon atoms, and more preferably an ethoxy group or a methoxy group from the viewpoint that there is less outgas generation during coating and the compound has more excellent storage stability.

Examples of the hydrocarbon group represented by L² include an alkyl group, a cycloalkyl group, an alkenyl group, and an allyl group, and from the viewpoint of ease of synthesis and the like, a saturated hydrocarbon group is preferable, and an alkyl group is more preferable. The number of carbon atoms in the hydrocarbon group is preferably from 1 to 6, more preferably from 1 to 3, and still more preferably from 1 to 2.

r1 is an integer from 1 to 3, and is preferably from 1 to 2 and more preferably 1 from the viewpoint of ease of synthesis.

Each of at least four of the plurality of L²s included in one group (S3) is a hydrolyzable group, a group having a hydrolyzable group, or a hydroxy group. As a result, the group (S3) and the substrate are more strongly bonded, and a surface treatment layer having excellent durability can be obtained. From such a viewpoint, the number of hydrolyzable groups, groups having a hydrolyzable group, and hydroxy groups in the group (S3) is preferably from 4 to 9, more preferably from 4 to 7, and still more preferably 4 or 5.

The plurality of L²s present in one molecule may be the same or different from each other. For example, a plurality of L²s may be the same hydrolyzable group.

Each P is independently an oxygen atom or an organic group having one carbon atom bonded to adjacent Si atoms. Here, the “organic group having one carbon atom bonded to adjacent Si atoms” means that Si atoms are linked to each other via one carbon atom. Examples of P include a hydrocarbon group, and P may be, for example, —CH₂—, —C(CH₃)₂—, or the like. From the viewpoint of durability of the surface treatment layer, P is preferably an oxygen atom, —CH₂—, or —C(CH₃)₂—, more preferably an oxygen atom or —CH₂—, and still more preferably an oxygen atom.

From the viewpoint that the surface treatment layer has excellent durability, the group (S3) is preferably —[Si(OR¹²)₂—O]ᵣ₁—Si(OR¹²)₃, and particularly preferably —Si(OR¹²)₂—O—Si(OR¹²)₃ in which r1=1. Here, each R¹² is independently a hydrocarbon group. Examples of the hydrocarbon group include an alkyl group, a cycloalkyl group, an alkenyl group, and an allyl group, and from the viewpoint of ease of synthesis, a saturated hydrocarbon group is preferable, and an alkyl group is more preferable. The number of carbon atoms in R¹² is preferably from 1 to 6, more preferably from 1 to 3, and still more preferably 1 or 2.

Specific examples of the group (S3) include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

When there is a plurality of groups Y² in one molecule, the plurality of groups Y may be the same or different from each other. From the viewpoint of ease of availability of the raw material and ease of production of the compound, the plurality of groups Y² are preferably the same.

The group Y² in the first compound and the group Y² in the second compound may be the same as or different from each other. The group Y² in the first compound and the group Y² in the second compound are preferably the same from the viewpoint of improving the balance among an antifouling property, fingerprint removability, and slipperiness. When the composition contains the third compound, the group Y² in the first compound, the group Y² in the second compound, and the group Y² in the third compound may all be the same as each other, only two of them may be the same as each other, or all may be different from each other. The group Y² in the first compound, the group Y² in the second compound, and the group Y² in the third compound are all preferably the same as each other from the viewpoint of improving the balance among an antifouling property, fingerprint removability, and slipperiness.

### SPECIFIC EXAMPLES

Among specific examples of the compound (A), examples of compounds other than the specific examples of the compound (1) described above include the following compounds. In the following formulae, m has the same meaning as m in Formula (A).

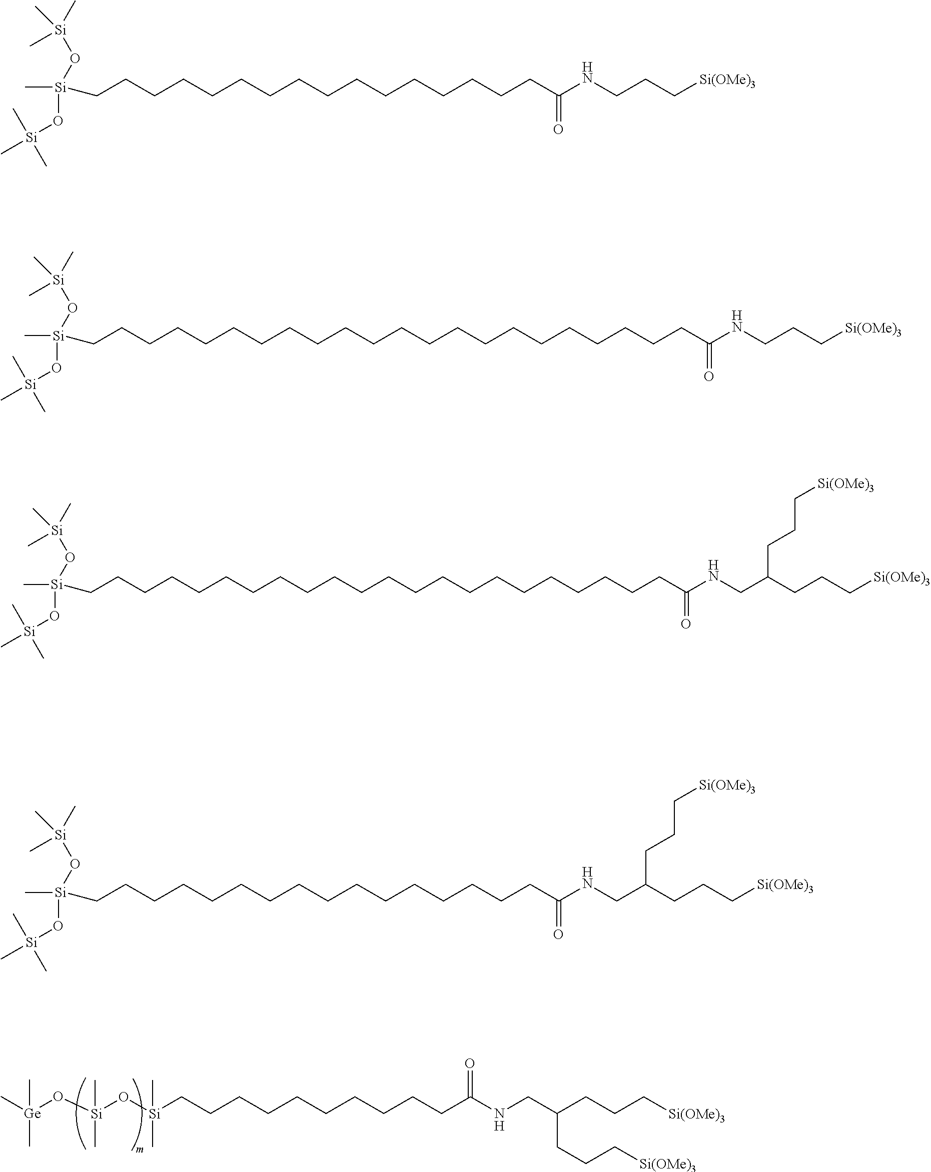

The preferred range of the number average molecular weight (Mn) of the compound (A) is the same as the preferred range of the number average molecular weight (Mn) of the compound (1) described above.

The composition of the disclosure may contain impurities such as by-products generated in the production step of the compound (A).

### (Content Amount)

The preferred range of the content percentage of each compound in the composition of the disclosure containing two or more kinds of compounds (A) is the same as the content percentage of each compound in the first composition described above.

The preferred range of the content percentage of each compound when the composition of the disclosure contains three or more kinds of compounds (A) is the same as the content percentage of each compound in the first composition described above.

The preferred range of the total content amount of the two or more kinds of compounds (A) with respect to the total amount of the composition of the disclosure is the same as the total content amount of the two or more kinds of compounds (1) with respect to the total amount of the first composition described above.

### <Liquid Medium>

The composition of the disclosure preferably further contains a liquid medium.

When the composition of the disclosure includes a liquid medium, the composition of the disclosure only needs to be a liquid, may be a solution, or may be a dispersion.

The liquid medium contained in the composition of the disclosure may be only one kind, or may be two or more kinds.

The liquid medium is preferably an organic solvent.

Examples of the organic solvent include a compound formed only of a hydrogen atom and a carbon atom, and a compound formed only of a hydrogen atom, a carbon atom, and an oxygen atom, and specific examples thereof include a hydrocarbon-based organic solvent, a ketone-based organic solvent, an ether-based organic solvent, an ester-based organic solvent, a glycol-based organic solvent, and an alcohol-based organic solvent.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono-tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, riethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvent include a halogen-based organic solvent, a nitrogen-containing compound, a sulfur-containing compound, a siloxane compound, and a fluorine-containing organic solvent.

Specific examples of the halogen-based organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of the fluorine-containing organic solvent include a polyfluoroaromatic hydrocarbon (for example, 1,3-bis(trifluoromethyl)benzene); a polyfluoroaliphatic hydrocarbon (for example, C₆F₁₃CH₂CH₃ (for example, ASAHIKLIN (registered trademark) AC-6000 manufactured by AGC Inc.), 1,1,2,2,3,3,4-heptafluorocyclopentane (for example, ZEORORA (registered trademark) H manufactured by Zeon Corporation); a hydrofluoroether (HFE) (for example, an alkyl perfluoroalkyl ether (a perfluoroalkyl group and an alkyl group may be linear or branched) such as perfluoropropyl methyl ether (C₃F₇OCH₃) (for example, Novec (trademark) 7000 manufactured by Sumitomo 3M Limited.), perfluorobutyl methyl ether (C₄F₉OCH₃) (for example, Novec (trademark) 7100 manufactured by Sumitomo 3M Limited.), perfluorobutyl ethyl ether (C₄F₉OC₂H₅) (for example, Novec (trademark) 7200 manufactured by Sumitomo 3M Limited.), or perfluorohexyl methyl ether (C₂F₅CF(OCH₃)C₃F₇) (for example, Novec (trademark) 7300 manufactured by Sumitomo 3M Limited.), or CF₃CH₂OCF₂CHF₂ (for example, ASAHIKLIN (registered trademark) AE-3000 manufactured by AGC Inc.)); a hydrofluoroolefin (HFO) (for example, 1-chloro-2,3,3-trifluoro-1-propene (HCFO-1233yd) (for example, AMOREA (registered trademark) AS-300 manufactured by AGC Inc.), and Opteon (registered trademark) SF01, SF05, SF10, SF30, SF33, SF70, SF79, and SF80 manufactured by Chemours Company).

The content amount of the liquid medium is preferably from 50 to 99.999 mass %, more preferably from 80 to 99.99 mass %, and still more preferably from 90 to 99.9 mass % with respect to the total amount of the composition of the disclosure. In the case of the composition of the disclosure used in a wet coating method, the content amount of the liquid medium may be from 90 to 99.99 mass %, from 95 to 99.98 mass %, from 97 to 99.97 mass %, or from 98 to 99.95 mass % with respect to the total amount of the composition of the disclosure.

### <Other Components>

The composition of the disclosure may contain other components in addition to the compound (A) and the liquid medium as long as the effects of the disclosure are not impaired.

Examples of other components include known additives such as an acid catalyst and a basic catalyst that promote hydrolysis and a condensation reaction of the group Y² in the compound (A).

As the catalyst, any appropriate acid or base, a transition metal (for example, Ti, Ni, Sn, Zr, Al, B, or the like), a sulfur-containing compound having an unshared electron pair in the molecular structure, a nitrogen-containing compound (for example, a sulfoxide compound, an aliphatic amine compound, an aromatic amine compound, a phosphoric acid amide compound, an amide compound, or a urea compound), or the like can be used.

Examples of the acid catalyst include acetic acid, formic acid, trifluoroacetic acid, hydrochloric acid, nitric acid, sulfuric acid, phosphoric acid, sulfonic acid, methanesulfonic acid, and p-toluenesulfonic acid.

Examples of the base catalyst include ammonia, sodium hydroxide, potassium hydroxide; and an organic amine such as triethylamine or diethylamine.

Examples of other components also include a metal compound having a hydrolyzable group (hereinafter, a metal compound having a hydrolyzable group is also referred to as “specific metal compound”). When the composition of the disclosure contains a specific metal compound, the slipperiness and antifouling property of the surface treatment layer can be further improved. Examples of the specific metal compound include Formulae (M1) to (M3) below.

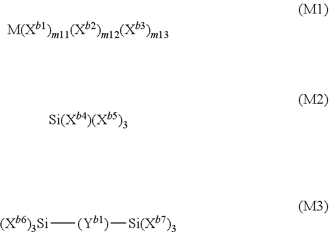

In Formula (M1),
M represents a trivalent or tetravalent metal atom.
Each X^{b1} independently represents a hydrolyzable group.
Each X^{b2} independently represents a siloxane backbone-containing group.
Each X^{b3} independently represents a hydrocarbon chain-containing group.
m11 is an integer from 2 to 4,
each of m12 and m13 is independently an integer from 0 to 2,
when M is a trivalent metal atom, m11+m12+m13 is 3, and when M is a tetravalent metal atom, m11+m12+m13 is 4.

In Formula (M2),
X^{b4} represents a hydrolyzable silane oligomer residue.

Each X⁵ independently represents a hydrolyzable group or an alkyl group having from 1 to 4 carbon atoms.

In Formula (M3),
each X^{b6} and X^{b7} independently represents a hydrolyzable group or a hydroxy group.
Y^{b1} represents a divalent organic group.

Examples of the metal represented by M in Formula (M1) also include metalloids such as Si and Ge. M is preferably a trivalent metal or a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include those the same as the hydrolyzable group represented by L in [—Si(R²)ₙL₃₋ₙ] in Formula (1).

The siloxane backbone-containing group represented by X^{b2} has a siloxane unit (—Si—O—), and may be linear or branched. The siloxane unit is preferably a dialkylsilyloxy group, and examples thereof include a dimethylsilyloxy group and a diethylsilyloxy group. The number of repetitions of the siloxane unit in the siloxane backbone-containing group is 1 or more, preferably from 1 to 5, more preferably from 1 to 4, and still more preferably from 1 to 3.

The siloxane backbone-containing group may contain a divalent hydrocarbon group in part of the siloxane backbone. Specifically, some oxygen atoms of the siloxane backbone may be replaced by divalent hydrocarbon groups. Examples of the divalent hydrocarbon group include alkylene groups such as a methylene group, an ethylene group, a propylene group, and a butylene group.

A hydrolyzable group, a hydrocarbon group (preferably an alkyl group) or the like may be bonded to a silicon atom at a terminal of the siloxane backbone-containing group.

The number of atoms of the siloxane backbone-containing group is preferably 100 or less, more preferably 50 or less, and still more preferably 30 or less. The number of atoms is preferably 10 or more.

The siloxane backbone-containing group is preferably a group represented by *—(O—Si(CH₃)₂)ₙCH₃, in which n is an integer from 1 to 5, and * represents a bonding site to an adjacent atom.

The hydrocarbon chain-containing group represented by X^{b3} may be a group formed only of a hydrocarbon chain, or may be a group having an ether oxygen atom between carbon atoms in a hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably from 1 to 3, more preferably from 1 to 2, and still more preferably 1. The hydrocarbon chain-containing group is preferably an alkyl group, and more preferably a methyl group, an ethyl group, or a propyl group.

m1 is preferably 3 or 4.

As the compound represented by Formula (M1), compounds represented by the following Formulae (M1-1) to (M1-5) in which M is Si are preferable, and a compound represented by Formula (M1-1) is more preferable. The compound represented by Formula (M1-1) is preferably tetraethoxysilane, tetramethoxysilane, or triethoxymethylsilane.

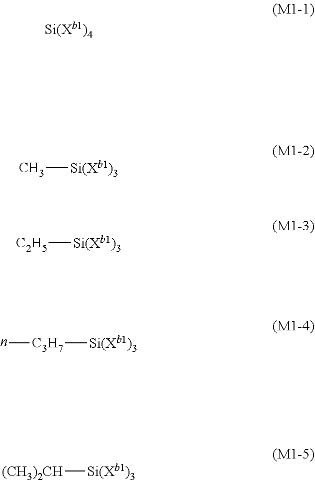

In Formula (M2), the number of silicon atoms contained in the hydrolyzable silane oligomer residue represented by X^{b4} is preferably 3 or more, more preferably 5 or more, and still more preferably 7 or more. The number of silicon atoms is preferably 15 or less, more preferably 13 or less, and still more preferably 10 or less.

The hydrolyzable silane oligomer residue may have an alkoxy group bonded to a silicon atom. Examples of the alkoxy group include a methoxy group, an ethoxy group, a propoxy group, and a butoxy group, and a methoxy group and an ethoxy group are preferable. The hydrolyzable silane oligomer residue may have one kind or two or more kinds of these alkoxy groups, and preferably has one kind.

Examples of the hydrolyzable silane oligomer residue include (C₂H₅O)₃Si—(OSi(OC₂H₅)₂)₄O—*. Here, * represents a bonding site to an adjacent atom.

Examples of the hydrolyzable group represented by X^{b5} in Formula (M2) include those the same as the hydrolyzable group represented by L in [—Si(R²)ₙL₃₋ₙ] in the reactive silyl group, a cyano group, a hydrogen atom, and an allyl group, and an alkoxy group or an isocyanato group is preferable. The alkoxy group is preferably an alkoxy group having from 1 to 4 carbon atoms.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both terminals of a divalent organic group, that is, bis-silane.

Examples of the hydrolyzable group represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. An alkoxy group and an isocyanato group are preferable. As the alkoxy group, an alkoxy group having from 1 to 4 carbon atoms is preferable, and a methoxy group and an ethoxy group are more preferable.

In Formula (M3), X^{b6} and X^{b7} may be the same groups as each other or may be different groups from each other. From the viewpoint of availability, X^{b6} and X^{b7} are preferably the same groups as each other.

In Formula (M3), Y^{b1} is a divalent organic group that links reactive silyl groups at both terminals. The number of carbon atoms in Y^{b1} of the divalent organic group is preferably from 1 to 8, and more preferably from 1 to 3.

Examples of Y^{b1} include an alkylene group, a phenylene group, and an alkylene group having an ether oxygen atom between carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include (CH₃₀)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃₀)₃Si(CH₂)₆Si(OCH₃)₃, (C₂H₅O)₃Si(CH₂)₆Si(OC₂H₅)₃.

The content amount of other components that may be contained in the composition of the disclosure is preferably 10 mass % or less, and more preferably 1 mass % or less with respect to the total amount of the composition of the disclosure. When the composition of the disclosure contains a specific metal compound, the content amount of the specific metal compound is preferably from 0.01 to 30 mass %, more preferably from 0.01 to 10 mass %, and still more preferably from 0.05 to 5 mass % with respect to the total amount of the composition of the disclosure.

The total content amount of the compound (A) and other components (hereinafter also referred to as “solid content concentration”) is preferably from 0.001 to 50 mass %, more preferably from 0.01 to 20 mass %, and still more preferably from 0.1 to 10 mass % with respect to the total amount of the composition of the disclosure. The solid content concentration of the composition of the disclosure is a value calculated from the mass before heating and the mass after heating in a convection dryer at 120° C. for 4 hours.

When the composition of the disclosure contains a liquid medium, the composition of the disclosure is useful as a coating application and can be used as a coating liquid.

### [Surface Treatment Agent]

The surface treatment agent of the disclosure includes the composition described above. The surface treatment agent of the disclosure contains two or more kinds of compounds (A), which are mutually different in at least one of the group T or the group Y¹, and may contain a liquid medium if necessary, or may contain other components other than the compound (A) and the liquid medium.

Since the surface treatment agent of the disclosure contains two or more kinds of compounds (A) which are mutually different in at least one of the group T or the group Y¹, it is possible to form a surface treatment layer having an antifouling property, fingerprint removability, and slipperiness in a well-balanced manner.

### [Article]

In one aspect, an article of the disclosure includes a substrate and a surface treatment layer disposed on the substrate and formed by a surface treatment using the surface treatment agent of the disclosure.

The surface treatment layer may be formed on part of the surface of the substrate, or may be formed on the entire surface of the substrate. The surface treatment layer may spread in a film shape on the surface of the substrate, or may be dispersed in a dot-like pattern.

In the surface treatment layer, the compound (A) contained in the composition of the disclosure is contained in a state in which hydrolysis of some or all of the groups Y² has progressed and a dehydration condensation reaction of a silanol group has progressed.

The thickness of the surface treatment layer is preferably from 1 to 100 nm, and more preferably from 1 to 50 nm. When the thickness of the surface treatment layer is 1 nm or more, the effect of the surface treatment is sufficiently obtained easily. When the thickness of the surface treatment layer is 100 nm or less, utilization efficiency is high. The thickness of the surface treatment layer can be calculated from the oscillation period of an interference pattern by obtaining the interference pattern of reflected X-rays by an X-ray reflectivity method using an X-ray diffractometer for thin film analysis (product name “ATX-G”, manufactured by Rigaku Corporation).

The kind of the substrate is not particularly limited, and examples thereof include a substrate required to be imparted with water repellency. Examples of the substrate include a substrate that may be used by bringing another article (for example, a stylus) or a human finger into contact therewith; a substrate that may be held with a human finger during an operation; and a substrate that may be placed on another article (for example, a mounting table).

Examples of the material of the substrate include a metal, a resin, glass, sapphire, a ceramic, a semiconductor, stone, fiber, a nonwoven fabric, paper, wood, fur, natural leather, artificial leather, ceramic ware, and composite materials thereof. The glass may be chemically strengthened.

Examples of the substrate include a building material, a decorative building material, an interior good, transportation equipment (for example, an automobile), a signboard, a bulletin board, a drinking vessel, tableware, a water tank, an ornamental instrument (for example, a frame or a box), a laboratory instrument, furniture, a textile product, or a packaging container; glass or a resin used for art, sports, or games; or glass or a resin used for an exterior part (excluding a display portion) of a device such as a mobile phone (for example, a smartphone), a portable information terminal, a game console, or a remote controller. The shape of the substrate may be a plate shape or a film shape.

As the substrate, a substrate for a touch panel, a substrate for a display, and a spectacle lens are suitable, and a substrate for a touch panel is particularly suitable. The material of the substrate for a touch panel is preferably glass or a transparent resin.

The substrate may be a substrate having one surface or both surfaces subjected to a surface treatment such as a corona discharge treatment, a plasma treatment, or a plasma graft polymerization treatment. The substrate subjected to a surface treatment has more excellent adhesion to the surface treatment layer, and the wear resistance of the surface treatment layer is further improved. Therefore, it is preferable to subject the surface of the substrate on the side in contact with the surface treatment layer to a surface treatment. When an underlying layer described later is provided, the substrate subjected to a surface treatment has more excellent adhesion to the underlying layer, and the wear resistance of the surface treatment layer is further improved. Therefore, when the underlying layer is provided, it is preferable to subject the surface of the substrate on the side in contact with the underlying layer to a surface treatment.

The surface treatment layer may be provided directly on the surface of the substrate, or an underlying layer may be provided between the substrate and the surface treatment layer. From the viewpoint of further improving the water repellency and wear resistance of the surface treatment layer, the article of the disclosure preferably includes a substrate, an underlying layer disposed on the substrate, and a surface treatment layer disposed on the underlying layer and formed by a surface treatment using the surface treatment agent of the disclosure.

The underlying layer is preferably a layer containing an oxide containing silicon and at least one specific element selected from the group consisting of a group 1 element, a group 2 element, a group 4 element, a group 5 element, a group 13 element, and a group 15 element in the periodic table.

The group 1 element in the periodic table (hereinafter also referred to as “group 1 element”) means lithium, sodium, potassium, rubidium, and cesium. As the group 1 element, lithium, sodium, and potassium are preferable, and sodium and potassium are more preferable from the viewpoint that the surface treatment layer can be more uniformly formed on the underlying layer without defects, or the variation in the composition of the underlying layer among samples is further suppressed. The underlying layer may contain two or more kinds of group 1 elements.

The group 2 element in the periodic table (hereinafter also referred to as “group 2 element”) means beryllium, magnesium, calcium, strontium, and barium. As the group 2 element, magnesium, calcium, and barium are preferable, and magnesium and calcium are more preferable from the viewpoint that the surface treatment layer can be more uniformly formed on the underlying layer without defects, or the variation in the composition of the underlying layer among samples is further suppressed. The underlying layer may contain two or more kinds of group 2 elements.

The group 4 element in the periodic table (hereinafter also referred to as “group 4 element”) means titanium, zirconium, and hafnium. As the group 4 element, titanium and zirconium are preferable, and titanium is more preferable from the viewpoint that the surface treatment layer can be more uniformly formed on the underlying layer without defects, or the variation in the composition of the underlying layer among samples is further suppressed. The underlying layer may contain two or more kinds of group 4 elements.

The group 5 element in the periodic table (hereinafter also referred to as “group 5 element”) means vanadium, niobium, and tantalum. As the group 5 element, vanadium is particularly preferable from the viewpoint that the surface treatment layer has more excellent wear resistance. The underlying layer may contain two or more kinds of group 5 elements.

The group 13 element in the periodic table (hereinafter also referred to as “group 13 element”) means boron, aluminum, gallium, and indium. As the group 13 element, boron, aluminum, and gallium are preferable, and boron and aluminum are more preferable from the viewpoint that the surface treatment layer can be more uniformly formed on the underlying layer without defects, or the variation in the composition of the underlying layer among samples is further suppressed. The underlying layer may contain two or more kinds of group 13 elements.

The group 15 element in the periodic table (hereinafter also referred to as “group 15 element”) means nitrogen, phosphorus, arsenic, antimony, and bismuth. As the group 15 element, phosphorus, antimony, and bismuth are preferable, and phosphorus and bismuth are more preferable from the viewpoint that the surface treatment layer can be more uniformly formed on the underlying layer without defects, or the variation in the composition of the underlying layer among samples is further suppressed. The underlying layer may contain two or more kinds of group 15 elements.

As the specific element contained in the underlying layer, a group 1 element, a group 2 element, and a group 13 element are preferable because the surface treatment layer has more excellent wear resistance, a group 1 element and a group 2 element are more preferable, and a group 1 element is still more preferable.

As the specific element, only one kind of element may be contained, or two or more kinds of elements may be contained.

The oxide contained in the underlying layer may be a mixture of oxides of the above elements (silicon and specific elements) alone (for example, a mixture of silicon oxide and an oxide of a specific element), a composite oxide containing two or more kinds of the above elements, or a mixture of an oxide of the above elements alone and a composite oxide.

The ratio of the total molar concentration of the specific element in the underlying layer to the molar concentration of silicon in the underlying layer (specific element/silicon) is preferably from 0.02 to 2.90, more preferably from 0.10 to 2.00, and still more preferably from 0.20 to 1.80 from the viewpoint that the surface treatment layer has more excellent wear resistance.

The molar concentration (mol %) of each element in the underlying layer can be measured, for example, by depth direction analysis using X-ray photoelectron spectroscopy (XPS) with ion sputtering.

The underlying layer may be a single layer or a multilayer. The underlying layer may have irregularities on the surface.

The thickness of the underlying layer is preferably from 1 to 100 nm, more preferably from 1 to 50 nm, and still more preferably from 2 to 20 nm. When the thickness of the underlying layer is the above lower limit value or more, the adhesion of the surface treatment layer due to the underlying layer is further improved, and the surface treatment layer has more excellent wear resistance. When the thickness of the underlying layer is the above upper limit value or less, the underlying layer itself has excellent wear resistance.

The thickness of the underlying layer is measured through cross-sectional observation of the underlying layer with a transmission electron microscope (TEM).

The underlying layer can be formed, for example, by a vapor deposition method using a vapor deposition material or a wet coating method.

The vapor deposition material used in the vapor deposition method preferably contains an oxide containing silicon and a specific element.

Specific examples of the form of the vapor deposition material include a powder, a molten body, a sintered body, a granulated body, and a crushed body, and from the viewpoint of handleability, a molten body, a sintered body, and a granulated body are preferable.

Here, the molten body means a solid obtained by melting a powder of a vapor deposition material at a high temperature, followed by cooling and solidification. The sintered body means a solid obtained by firing a powder of a vapor deposition material, and instead of a powder of a vapor deposition material, a molded body obtained by press-forming the powder may be used if necessary. The granulated body means a solid obtained by kneading a powder of a vapor deposition material and a liquid medium (for example, water or an organic solvent) to obtain particles and then drying the particles.

The vapor deposition material can be produced, for example, by the following method.
A method in which a powder of silicon oxide and a powder of an oxide of a specific element are mixed to obtain a powder of a vapor deposition material.
A method in which the powder of a vapor deposition material and water are kneaded to obtain particles, and then the particles are dried to obtain a granulated body of a vapor deposition material.
A method in which a mixture obtained by mixing a powder containing silicon (for example, a powder made of silicon oxide, silica sand, or silica gel), a powder containing a specific element (for example, a powder of an oxide of a specific element, a carbonate, a sulfate, a nitrate, an oxalate, or a hydroxide), and water is dried, and then firing the dried mixture or a molded body obtained by press-molding this to obtain a sintered body.
A method in which a powder containing silicon (for example, a powder made of silicon oxide, silica sand, or silica gel), a powder containing a specific element (for example, a powder of an oxide of a specific element, a carbonate, a sulfate, a nitrate, an oxalate, or a hydroxide) are melted at a high temperature, and then the melt is cooled and solidified to obtain a molten body.

Specific examples of the vapor deposition method using the vapor deposition material include a vacuum deposition method. The vacuum deposition method is a method in which the vapor deposition material is evaporated in a vacuum chamber and attached to a surface of a substrate.

The temperature (for example, when a vacuum deposition apparatus is used, the temperature of a boat on which the vapor deposition material is disposed) during vapor deposition is preferably from 100 to 3,000° C., and more preferably from 500 to 3,000° C.

The pressure (for example, when a vacuum deposition apparatus is used, the pressure in the chamber in which the vapor deposition material is disposed) during vapor deposition is preferably 1 Pa or less, and more preferably 0.1 Pa or less.

When the underlying layer is formed using the vapor deposition material, one vapor deposition material may be used, or two or more vapor deposition materials containing different elements may be used.

Specific examples of the method of evaporating the vapor deposition material include a resistance heating method in which the vapor deposition material is melted and evaporated on a resistance heating boat made of a high melting point metal, and an electron gun method in which the vapor deposition material is irradiated with an electron beam and directly heated to melt and evaporate the surface. As a method of evaporating the vapor deposition material, an electron gun method is preferable from the viewpoint that a high melting point substance can also be evaporated because local heating is possible, and from the viewpoint that there is no risk of reaction with a container or contamination with impurities because a portion not hit by an electron beam is at a low temperature.

In the method of evaporating the vapor deposition material, a plurality of boats may be used, or all vapor deposition materials may be placed in a single boat and used. The vapor deposition method may be co-vapor deposition, alternate vapor deposition, or the like. Specifically, examples include a case where silica and a specific source are mixed in the same boat and used, a case where silica and a specific element source are placed in separate boats and co-deposited, and a case where silica and a specific element source are placed in separate boats similarly and alternately deposited. Conditions, order, and the like of vapor deposition are selected as appropriate according to the configuration of the underlying layer.

In the wet coating method, it is preferable to form an underlying layer on a substrate by a wet coating method using a coating liquid containing a compound containing silicon, a compound containing a specific element, and a liquid medium.

Specific examples of the silicon compound include silicon oxide, silicic acid, a partial condensate of silicic acid, alkoxysilane, and a partial hydrolysis condensate of alkoxysilane.

Specific examples of the compound containing a specific element include an oxide of a specific element, an alkoxide of a specific element, a carbonate of a specific element, a sulfate of a specific element, a nitrate of a specific element, an oxalate of a specific element, and a hydroxide of a specific element.

Examples of the liquid medium include those the same as the liquid medium that may be contained in the composition of the disclosure.

The content amount of the liquid medium is preferably from 80 to 99.99 mass %, and more preferably from 90 to 99.9 mass % with respect to the total amount of the coating liquid used for forming the underlying layer.

Specific examples of the wet coating method for forming the underlying layer include a spin coating method, a wipe coating method, a spray coating method, a squeegee coating method, a dip coating method, a die coating method, an inkjet method, a flow coating method, a roll coating method, a casting method, a Langmuir-Blodgett method, or a gravure coating method.

It is preferable to dry the coating film after wet coating with the coating liquid. The drying temperature of the coating film is preferably from 20 to 200° C., and more preferably from 80 to 160° C.

The article of the disclosure may be an optical material having a surface treatment layer as the outermost layer.

Preferred examples of the optical material include optical materials related to displays and the like as well as a wide variety of other optical materials.

Examples of the optical material include a display such as a cathode ray tube (CRT, for example, a personal computer monitor), a liquid crystal display, a plasma display, an organic EL display, an inorganic thin film EL dot matrix display, a rear projection-type display, a fluorescent display tube (VFD), or a field emission display (FED), a protective plate for the display, and one having a surface subjected to an antireflection film treatment.

The article of the disclosure is preferably an optical member. Examples of the optical member include an automotive navigation system, a mobile phone, a smartphone, a digital camera, a digital video camera, a PDA, a portable audio player, a car audio, a game console, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an antireflection film.

Examples of the optical member include a front protective plate, an antireflection plate, a polarizing plate, and an anti-glare plate of a display such as a PDP or an LCD; a disc surface of an optical disk such as a Blu-ray (registered trademark) disc, a DVD disc, CD-R, or MO; an optical fiber; and a display surface of a watch.

In particular, the article of the disclosure is preferably a display or a touch panel.

The article of the disclosure may be a medical device or a medical material. The article of the disclosure may be an automobile interior or exterior member. Examples of the exterior material include a window, a light cover, or an exterior camera cover. Examples of the interior material include an instrument panel cover, a navigation system touch panel, or a decorative interior material.

When the article of the disclosure is an optical member, the material forming the surface of the substrate is a material for an optical member, for example, glass or transparent plastic. When the article of the disclosure is an optical member, a functional layer such as a hard coat layer or an antireflection layer may be formed on the surface (outermost layer) of the substrate. The antireflection layer may be either a single-layer antireflection layer or a multilayer antireflection layer.

Examples of an inorganic substance that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used singly, or in combination of two or more kinds thereof (for example, as a mixture). In the case of a multilayer antireflection layer, it is preferable to use SiO₂ and/or SiO as the outermost layer. When the article of the disclosure is an optical glass component for a touch panel, a transparent electrode, for example, a thin film in which indium tin oxide (ITO), indium zinc oxide, or the like is used may be provided on part of the surface of the substrate (glass). In addition, the substrate may have an insulating layer, an adhesive layer, a protective layer, a decorative frame layer (I-CON), an atomized film layer, a hard coating film layer, a polarizing film, a phase difference film, a liquid crystal display module, or the like according to the specific specification thereof or the like.

### [Method of Producing Article]

The method of producing an article of the disclosure is, for example, a method in which a substrate is subjected to a surface treatment using the surface treatment agent of the disclosure to produce an article having a surface treatment layer formed on the substrate. Examples of the surface treatment include a dry coating method and a wet coating method.

Examples of the dry coating method include methods such as vacuum deposition, CVD, or sputtering. As the dry coating method, a vacuum deposition method is preferable from the viewpoint of suppressing decomposition of the compound and simplicity of the apparatus. At the time of vacuum deposition, a pellet-like substance obtained by impregnating a metal porous body of iron, steel, or the like with the compound of the disclosure may be used. A pellet-like substance impregnated with the compound of the disclosure obtained by impregnating a metal porous body of iron, steel, or the like with a composition containing the compound of the disclosure and a liquid medium and drying the liquid medium may be used.

Examples of the wet coating method include a spin coating method, a wipe coating method, a spray coating method, a squeegee coating method, a dip coating method, a die coating method, an inkjet method, a flow coating method, a roll coating method, a casting method, a Langmuir-Blodgett method, or a gravure coating method.

In order to improve the wear resistance of the surface treatment layer, an operation for promoting a reaction between the compound of the disclosure and the substrate may be performed if necessary. Examples of the operation include heating, humidification, and light irradiation.

For example, the substrate on which the surface treatment layer is formed can be heated in the atmosphere with moisture to promote a reaction such as a hydrolysis reaction of a hydrolyzable group, a reaction between a hydroxy group or the like on the surface of the substrate and a silanol group, or generation of a siloxane bond by a condensation reaction of a silanol group.

After the surface treatment, a compound, which is in the surface treatment layer, and is not chemically bonded to another compound or the substrate, may be removed if necessary. Examples of the removal method include a method of pouring a solvent on the surface treatment layer and a method of wiping with a cloth soaked with a solvent.

### EXAMPLES

Hereinafter, the invention will be described in more detail with reference to examples, but the invention is not limited to these examples.

### Synthesis of Compound A5

Under a nitrogen atmosphere, 2,3,4,5,6-pentafluorophenol (6.8 g), THF (tetrahydrofuran, 42 mL) and triethylamine (5.1 g) were added to a 100 mL flask and stirred at 25° C. To the reaction mixture, 10-undecenoyl chloride (5.0 g) was added dropwise, followed by stirring for 1 hour. The reaction liquid was filtered, and the solvent and volatiles were distilled off under reduced pressure, and flash column chromatography (developing solvent: hexane/ethyl acetate) using silica gel was performed to obtain 7.9 g of a compound A1. The structure of the compound A1 was identified based on the following NMR data.

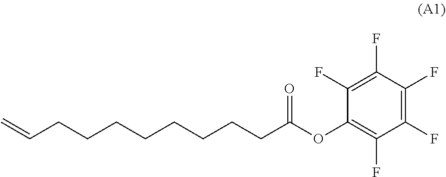 [SMILES: C=CCCCCCCCCC(=O)Oc1c(F)c(F)c(F)c(F)c1F]

¹H-NMR (400 MHz, CDCl₃) δ5.74 (ddt, J=16.9, 10.2, 6.6 Hz, 1H), 5.05-4.77 (m, 2H), 2.59 (t, J=7.4 Hz, 2H), 1.97 (q, J=7.1 Hz, 2H), 1.70 (p, J=7.4 Hz, 2H), 1.42-1.08 (m, 10H).

Under a nitrogen atmosphere, the compound A1 (5.6 g), THF (5.0 mL), chlorodimethylsilane (2.3 g), and a xylene solution of a platinum/1,3-divinyl-1,1,3,3-tetramethyldisiloxane complex (platinum content amount: 3 mass %, 0.10 mL) were added to a 200 mL flask and stirred at 25° C. for 2 hours. The solvent and volatiles were distilled off under reduced pressure to obtain 7.2 g of a compound A2. The structure of the compound A2 was identified based on the following NMR data.

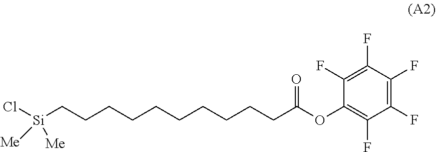 [SMILES: C[Si](C)(Cl)CCCCCCCCCCC(=O)Oc1c(F)c(F)c(F)c(F)c1F]

¹H-NMR (400 MHz, CDCl₃) δ 2.63 (t, J=7.4 Hz, 2H), 1.74 (p, J=7.4 Hz, 2H), 1.46-1.17 (m, 14H), 0.90-0.69 (m, 2H), 0.37 (s, 6H).

Under a nitrogen atmosphere, tris(trimethylsiloxy)silanol (1.3 g) and THF (20 mL) were added to a 200 mL three-necked flask and stirred. The mixture was cooled to 0° C., and a hexane solution of n-BuLi (1.6 M, 2.4 mL) was added dropwise thereto. A THF solution of hexamethylcyclotrisiloxane (1.0 M, 4.4 mL) was added dropwise thereto, and a THF solution of hexamethylcyclotrisiloxane (1.0 M, 22 mL) was further added dropwise thereto, followed by stirring for 6 hours. Then, the compound A2 (3.6 g) was added thereto, followed by stirring for 24 hours. Hexane and ion-exchanged water were sequentially added to the reaction liquid, followed by liquid separation, and an organic layer was collected. The solvent and volatiles were distilled off under reduced pressure, and flash column chromatography (developing solvent: hexane/ethyl acetate) using silica gel was performed to obtain 5.5 g of a compound A3. The structure of the compound A3 was identified based on the following NMR data. In the compound A3, the average value of m was 23.

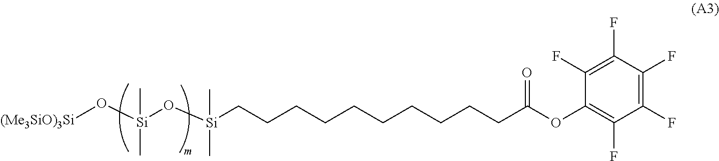

¹H-NMR (400 MHz, CDCl₃) δ 2.58 (t, J=7.4 Hz, 2H), 1.70 (p, J=7.4 Hz, 2H), 1.41-1.07 (m, 14H), 0.45 (t, J=7.4 Hz, 2H), 0.10 (s, 171H).

To a 200 mL flask, the compound A3 (1.0 g), 1,3-bis(trifluoromethyl)benzene (1.5 g), and 2,2-diallylpent-4-en-1-amine (0.25 g) were added and stirred at 25° C. for 3 hours. Hexane and ion-exchanged water were sequentially added to the reaction liquid, followed by liquid separation, and an organic layer was collected. The solvent and volatiles were distilled off under reduced pressure, and flash column chromatography (developing solvent: hexane/ethyl acetate) using silica gel was performed to obtain 0.35 g of a compound A4. The structure of the compound A4 was identified based on the following NMR data. In the compound A4, the average value of m was 23.

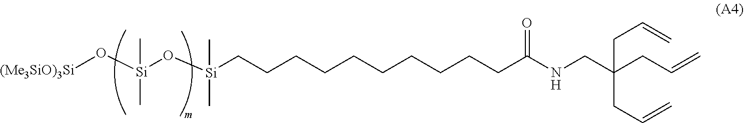

¹H-NMR (400 MHz, CDCl₃) δ 5.80 (ddt, J=17.7, 10.6, 7.4 Hz, 3H), 5.15-4.90 (m, 6H), 3.12 (d, J=6.3 Hz, 2H), 2.09 (t, J=7.5 Hz, 2H), 1.96 (dd, J=7.6, 1.3 Hz, 6H), 1.34-1.07 (m, 16H), 0.45 (t, J=7.6 Hz, 2H), 0.06-−0.10 (m, 171H).

To a 100 mL flask, dichloromethane (10 g), the compound A4 (0.33 g), a toluene solution of a platinum/1,3-divinyl-1,1,3,3-tetramethyldisiloxane complex (platinum content amount: 3 mass %, 4.1 mg), aniline (2.6 mg), and trimethoxysilane (0.40 g) were added and stirred at 25° C. for 2 hours. The solvent was distilled off under reduced pressure to obtain 0.38 g of a compound A5. The structure of the compound A5 was identified based on the following NMR data. In the compound A5, the average value of m was 23.

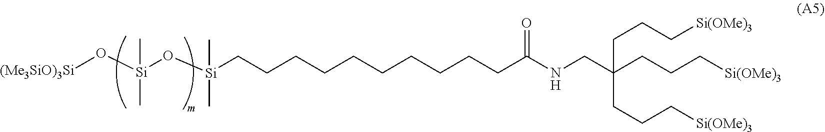

¹H-NMR (400 MHz, CDCl₃) δ 5.66 (d, J=6.4 Hz, 1H), 3.46 (d, J=29.0 Hz, 2H), 2.12 (t, J=7.5 Hz, 2H), 1.61-1.42 (m, 2H), 1.32-1.02 (m, 26H), 0.53 (t, J=7.7 Hz, 6H), 0.45 (t, J=7.0 Hz, 2H), 0.22-−0.24 (m, 171H).

### Synthesis of Compound A6

A compound A6 was obtained according to the synthesis method described in Synthesis Example 26 of Japanese Patent Application Laid-Open (JP-A) No. 2024-025757.

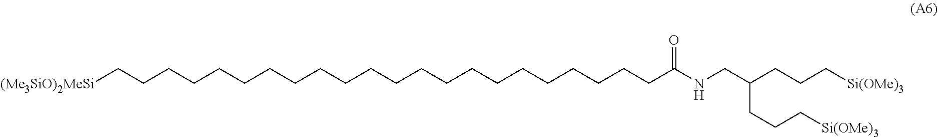

### Synthesis of Compound B2

Under a nitrogen atmosphere, carboxylic acid-terminated polydimethylsiloxane (the average value of m is 16, the number of carbon atoms in the alkylene group linked to the carboxy group is 10, manufactured by Gelest, Inc, product number: MCR-B12) (5.0 g), methylene chloride (20 mL), and oxalyl chloride (1.3 g) were added to a 200 mL flask and stirred at 25° C. for 2 hours. After the solvent and volatiles were distilled off under reduced pressure, 2,2-diallylpent-4-en-1-amine (1.2 g), methylene chloride (20 mL) and triethylamine (0.70 g) were added thereto and stirred at 25° C. for 2 hours. The solvent and volatiles were distilled off under reduced pressure, and flash column chromatography (developing solvent: hexane/ethyl acetate) using silica gel was performed to obtain 2.2 g of a compound B1. The structure of the compound B1 was identified based on the following NMR data. In the compound B1, the average value of m was 16.

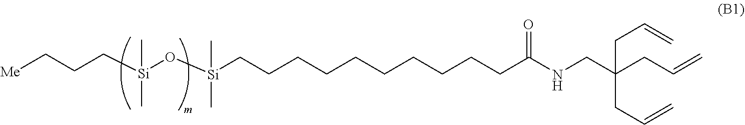

¹H-NMR (400 MHz, Chloroform-d) δ 5.85 (ddt, J=16.6, 10.5, 7.4 Hz, 3H), 5.48 (s, 1H), 5.17-4.98 (m, 6H), 3.18 (d, J=6.4 Hz, 2H), 2.19-2.09 (m, 2H), 2.01 (dt, J=7.4, 1.2 Hz, 6H), 1.54 (m, 2H), 1.40-1.06 (m, 18H), 0.94-0.76 (m, 3H), 0.59-0.38 (m, 4H), 0.05 (s, 102H).

To a 100 mL round-bottom flask, 1,3-bis(trifluoromethyl)benzene (2.0 mL), the compound B1 (1.0 g), a toluene solution of a platinum/1,3-divinyl-1,1,3,3-tetramethyldisiloxane complex (platinum content amount: 3 mass %, 15 L), aniline (4.8 L), and trimethoxysilane (0.31 g), were added and stirred at 40° C. for 2 hours. The solvent was distilled off under reduced pressure to obtain 1.1 g of a compound B2. The structure of the compound B2 was identified based on the following NMR data. In the compound B2, the average value of m was 16.

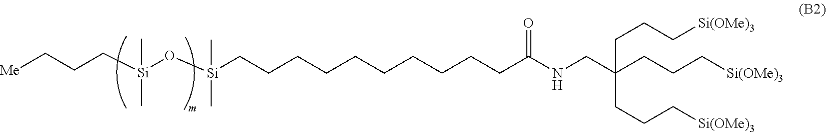

¹H-NMR (400 MHz, Chloroform-d) δ 5.65 (t, J=6.1 Hz, 1H), 3.49 (s, 27H), 3.04 (d, J=6.2 Hz, 2H), 2.18-2.04 (m, 2H), 1.37-0.95 (m, 32H), 0.95-0.72 (m, 3H), 0.69-0.36 (m, 10H), −0.07 (s, 102H).

### Synthesis of Compound C1

A compound C1 was obtained according to the synthesis method described in Example 1 of WO 2022/030495 A. In the compound C1, the average value of m was 19.

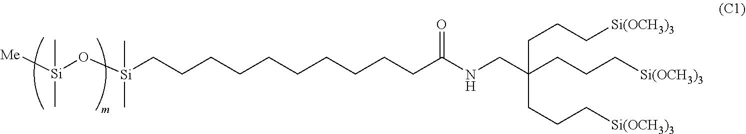

### Synthesis of Compound C2

A compound C2 was obtained according to the synthesis method described in Synthesis Example 6 of JP-A No. 2024-025757.

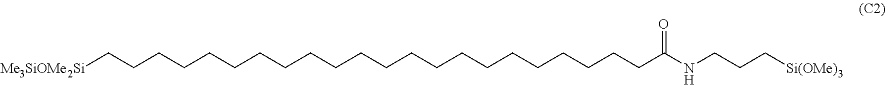

### [Preparation of Surface Treatment Agent and Formation of Surface Treatment Layer]

Heptane was used as a liquid medium, and each compound described in Tables 3 and 4 was added to the liquid medium in the addition amount (parts by mass) described in Tables 3 and 4 and mixed to obtain a surface treatment agent having a solid content concentration of 0.2 mass %.

The substrate was subjected to a surface treatment using the surface treatment agent. As the surface treatment method, a wet coating method was used.

### <Wet Coating Method>

As a vapor deposition source, 30 g of silicon oxide was disposed on a copper hearth in a vacuum deposition apparatus (VTR-350M manufactured by ULVAC KIKO, Inc.). A glass substrate was disposed in a vacuum deposition apparatus, and the inside of the vacuum deposition apparatus was evacuated until the pressure reached 5×10⁻³ Pa or less. The hearth was heated to about 2,000° C., and silicon oxide was vacuum-deposited on the surface of the substrate. Thereby, a silicon oxide layer having a thickness of about 20 nm was formed on the substrate.

The substrate on which the silicon oxide layer was formed was placed on a sample stage of a spray coater (API-90RS manufactured by Apiros Co., Ltd.) with the silicon oxide layer facing upward. Next, 13 g of the prepared surface treatment agent was charged into a syringe in the spray coater, and applied by spraying at an atomization pressure of 130 kPa, a nozzle-to-sample surface distance of 50 mm, and a scanning speed of 300 mm/sec. Thereafter, the coated substrate was subjected to a heat treatment at 140° C. for 30 minutes. Thereby, an article having a surface treatment layer on the surface of the silicon oxide layer was obtained.

### [Evaluation]

### <Evaluation of Antifouling Property>

With respect to the surface treatment layer of the obtained article, the antifouling property was evaluated by measuring the initial water contact angle and the initial oleic acid contact angle using the following measurement method.

Specifically, about 2 μL of distilled water or oleic acid was placed on the surface treatment layer of the article, and the initial water contact angle or the initial oleic acid contact angle was measured using a contact angle measuring device (product name “DM-500”, manufactured by Kyowa Interface Science Co., Ltd.). The measurement was performed at five locations on the surface treatment layer, and the average value was calculated. In the calculation of the water contact angle and the oleic acid contact angle, the 20 method was used. Evaluation criteria are as follows, and the larger each contact angle is, the more excellent the antifouling property is.

### (Evaluation Criteria for Antifouling Property Against Moisture)

A: The water contact angle is 105° or more.
B: The water contact angle is 100° or more but less than 105°.
C: The water contact angle is less than 100°.

### (Evaluation Criteria for Antifouling Property Against Oil)

A: The oleic acid contact angle is 55° or more.
B: The oleic acid contact angle is 50° or more but less than 55°.
C: The oleic acid contact angle is less than 50°.

### <Evaluation of Slipperiness>

With respect to the surface of the surface treatment layer of the obtained article, a dynamic friction coefficient was measured in accordance with ASTM D4917 using a surface property measuring device (FPT-1 manufactured by Labthink GmbH) with paper as a friction element.

Specifically, an article having a surface treatment layer was horizontally disposed, and paper (2 cm×2 cm) as a friction element was brought into contact with the exposed surface of the surface treatment layer, and a load of 1.96 N was applied thereon. Thereafter, in a state where a load was applied, the paper as the friction element was moved in parallel at a speed of 200 mm/sec, a dynamic friction coefficient was measured, and slipperiness was evaluated. The evaluation criteria are as follows, and the smaller the dynamic friction coefficient is, the more excellent the slipperiness is.

### (Evaluation Criteria for Slipperiness)

A: The dynamic friction coefficient is less than 0.10.
B: The dynamic friction coefficient is 0.10 or more but less than 0.15.
C: The dynamic friction coefficient is 0.15 or more.

### <Evaluation of Fingerprint Removability>

A 1 kg weight including a red rubber stopper having a diameter of 2 cm to become a fingerprint stamp portion was prepared.

Next, 70 μL of an artificial fingerprint liquid (manufactured by Isekyu Co., Ltd.) was applied onto a waste cloth, and a fingerprint stamp was attached to the artificial fingerprint liquid for 1 minute. In order to remove the artificial fingerprint liquid excessively attached to the fingerprint stamp, the fingerprint stamp was attached to a new waste cloth for 20 seconds. Thereafter, the article in which the surface treatment layer was formed was placed on a hot plate whose temperature was adjusted to 23° C. The fingerprint stamp was stamped onto the surface treatment layer.

The article to which the artificial fingerprint liquid was attached was placed on a sliding device (product name “HHS-2000”, manufactured by Shinto Scientific Co., Ltd.). A wiping cloth (SAVINA MINIMAX manufactured by KB SEIREN Co., Ltd.) was attached to a flat indenter having an area of 1 cm square using a double-sided tape, and the indenter was installed in a sliding device. The attached artificial fingerprint liquid was wiped off from the surface treatment layer in one direction with the wiping cloth under a load of 100 g. The haze at the wiped portion was measured with a haze meter (product name “NDH 7000SP”, manufactured by Nippon Denshoku Industries Co., Ltd.) to evaluate fingerprint removability. The evaluation criteria are as follows, and the smaller the haze value is, the more excellent the fingerprint removability is.

### (Evaluation Criteria for Fingerprint Removability)

A: The haze value is less than 0.1%.
B: The haze value is 0.1% or more but less than 0.15%.
C: The haze value is 0.15% or more.

The evaluation results are shown in Tables 3 and 4. Examples 1 to 9 and 13 to 21 are examples, and Examples 10 to 12 and 22 to 23 are comparative examples.

TABLE 3

| | Compound | | | Evaluation | | | |
|---|---|---|---|---|---|---|---|
| | Addition amount (parts by mass) | | | Antifouling property | | | Fingerprint |
| | A5 | B2 | C1 | Moisture | Oil | Slipperiness | removability |
| Example 1 | 75 | 25 | 0 | A | A | B | A |
| Example 2 | 50 | 50 | 0 | A | B | A | A |
| Example 3 | 25 | 75 | 0 | A | B | A | B |
| Example 4 | 75 | 0 | 25 | A | A | B | A |
| Example 5 | 50 | 0 | 50 | A | A | A | A |
| Example 6 | 25 | 0 | 75 | A | A | A | B |
| Example 7 | 50 | 25 | 25 | A | A | A | A |
| Example 8 | 25 | 50 | 25 | A | B | A | B |
| Example 9 | 25 | 25 | 50 | A | A | A | B |
| Example 10 | 100 | 0 | 0 | A | A | C | A |
| Example 11 | 0 | 100 | 0 | A | C | A | C |
| Example 12 | 0 | 0 | 100 | A | B | B | B |

TABLE 4

| | Compound | | | Evaluation | | | |
|---|---|---|---|---|---|---|---|
| | Addition amount (parts by mass) | | | Antifouling property | | | Fingerprint |
| | A6 | B2 | C2 | Moisture | Oil | Slipperiness | removability |
| Example 13 | 75 | 25 | 0 | A | A | B | A |
| Example 14 | 50 | 50 | 0 | A | B | A | A |
| Example 15 | 25 | 75 | 0 | A | B | A | B |
| Example 16 | 75 | 0 | 25 | A | A | B | A |
| Example 17 | 50 | 0 | 50 | A | A | A | A |
| Example 18 | 25 | 0 | 75 | A | A | A | B |
| Example 19 | 50 | 25 | 25 | A | A | A | A |
| Example 20 | 25 | 50 | 25 | A | B | A | B |
| Example 21 | 25 | 25 | 50 | A | A | A | B |
| Example 22 | 100 | 0 | 0 | A | A | C | A |
| Example 23 | 0 | 0 | 100 | A | B | B | B |

As shown in Table 3, in Examples 1 to 9, it was found that a surface treatment layer containing two or more kinds of compounds (1) and having an antifouling property, fingerprint removability, and slipperiness in a well-balanced manner can be formed.

As shown in Table 4, in Examples 13 to 21, it was found that a surface treatment layer containing two or more kinds of compounds (A) and having an antifouling property, fingerprint removability, and slipperiness in a well-balanced manner can be formed.

### INDUSTRIAL APPLICABILITY

The composition and the surface treatment agent of the disclosure can be used, for example, for a substrate in a display device such as a touch panel display, an optical element, a semiconductor element, a building material, an automobile component, a nanoimprint technology, or the like. The composition and the surface treatment agent can also be used for bodies, window glasses (windshield, side glass, and rear glass), mirrors, bumpers, and the like in transportation equipment such as trains, automobiles, ships, or aircraft. The composition and the surface treatment agent can also be used for outdoor articles such as building outer walls, tents, solar power generation modules, sound insulating plates, or concrete; fishing nets, insect trap nets, and water tanks. The composition and the surface treatment agent can also be used for a kitchen, a bathroom, a wash basin, a mirror, a toilet peripheral component, chandelier, ceramic ware such as tile, artificial marble, and various indoor facilities such as an air conditioner. The composition and the surface treatment agent can also be used for an antifouling treatment for jigs, inner walls, pipes, and the like in a factory. The composition and the surface treatment agent can also be used for goggles, glasses, helmets, pachinko, fibers, umbrellas, playground equipment, and soccer balls. The composition and the surface treatment agent can also be used as an adhesion inhibitor for various packaging materials such as food packaging materials or cosmetic packaging materials, and the inside of a pot. The composition and the surface treatment agent can also be used for an automotive navigation system, a mobile phone, a smartphone, a digital camera, a digital video camera, a PDA, a portable audio player, a car audio, a game console, a spectacle lens, a camera lens, a lens filter, sunglasses, a medical instrument such as a stomach camera, a copying machine, a PC, a display (for example, a liquid crystal display, an organic EL display, a plasma display, or a touch panel display), a touch panel, a protective film, and an optical member such as an antireflection film.

### SUPPLEMENTARY NOTE

The disclosure includes the following aspects.

<1>

A composition containing a first compound and a second compound, in which
each of the first compound and the second compound is represented by Formula (1), and T in Formula (1) of the first compound is different from T in Formula (1) of the second compound.

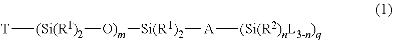

In Formula (1),
T is a monovalent group,
each R¹ is independently a monovalent hydrocarbon group,
A is a (q+1)-valent linking group,
each R² is independently a monovalent hydrocarbon group,
each L is independently a hydrolyzable group, a group having a hydrolyzable group, or a hydroxy group,
m is a number of 1 or more,
each n is independently an integer from 0 to 2, and
q is an integer of 1 or more.
   <2>

The composition according to <1>, in which in Formula (1), T is a methyl group, a linear alkyl group having 2 or more carbon atoms, an alkyl group having 3 or more carbon atoms and having at least one of a branched structure or a cyclic structure, a group represented by Formula (2A), or a group represented by Formula (2B).

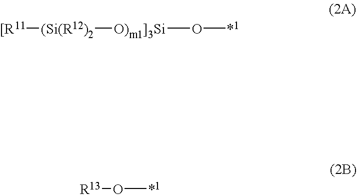

In Formulae (2A) to (2B),
each R¹¹ is independently a monovalent hydrocarbon group or a group R¹⁴₃Si—O—*², each of two or more of the three R¹¹s is R¹⁴₃Si—O—*², each R¹⁴ is independently a monovalent hydrocarbon group or a trialkylsilyloxy group, and *² is a bonding site to a silicon atom in Formula (2A),
each R¹² is independently a monovalent hydrocarbon group,
each m1 is independently a number of 0 or more,
R¹³ is a monovalent cyclic polysiloxane residue or a monovalent cage-like polysiloxane residue, and
*¹ is a bonding site to a silicon atom in Formula (1).
   <3>

The composition according to <1> or <2>, in which T in Formula (1) of the second compound is a methyl group, a linear alkyl group having 2 or more carbon atoms, or an alkyl group having 3 or more carbon atoms and having at least one of a branched structure or a cyclic structure.

<4>

The composition according to any one of <1> to <3>, in which T in Formula (1) of the first compound is a group represented by Formula (2A) or a group represented by Formula (2B).

<5>

The composition according to any one of <1> to <4>, in which q in Formula (1) is an integer from 1 to 4.

<6>

The composition according to any one of <1> to <5>, in which m in Formula (1) is a number from 3 to 500.

<7>

The composition according to any one of <1> to <6>, further containing a liquid medium.

<8>

A surface treatment agent including the composition according to any one of <1> to <7>.

<9>

A method of producing an article, the method including subjecting a substrate to a surface treatment using the surface treatment agent according to <8> to produce an article having a surface treatment layer formed on the substrate.

<10>

An article including a substrate and a surface treatment layer disposed on the substrate and formed by a surface treatment using the surface treatment agent according to <8>.

<11>

The article according to <10>, which is an optical member.

<12>

The article according to <10>, which is a display or a touch panel.

The disclosure of Japanese Patent Application No. 2023-174756 filed on Oct. 6, 2023 is incorporated herein by reference in its entirety. All documents, patent applications, and technical standards described in this description are incorporated herein by reference to the same extent as if each individual document, patent application, and technical standard were specifically and individually indicated to be incorporated by reference.

1. A composition comprising a first compound and a second compound, wherein the first compound and the second compound are each represented by Formula (A), and at least one of T or Y in Formula (A) differs between the first compound and the second compound: 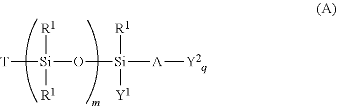
wherein, in Formula (A):
T is a monovalent group,
each R¹ is independently a monovalent hydrocarbon group,
Y¹ is a monovalent hydrocarbon group or a group represented by Formula (1A),
A is a (q+1)-valent linking group,
each Y² is independently a group represented by Formula (S1) or Formula (S3),
m is a number of 1 or more, and
q is an integer of 1 or more, 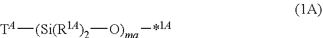
wherein, in Formula (1A):
T^{A} is a monovalent group,
each R^{1A} is independently a monovalent hydrocarbon group,
ma is a number of 1 or more, and
*^{1A} is a bonding site to a silicon atom in Formula (A), 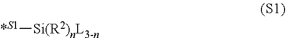
wherein, in Formula (S1):
each R² is independently a hydrocarbon group,
each L is independently a hydrolyzable group, a group having a hydrolyzable group, or a hydroxy group,
n is an integer from 0 to 2, and
*^{S1} is a bonding site to a linking group represented by A in Formula (A), 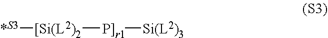
wherein, in Formula (S3):
each L² is independently a hydrolyzable group, a group having a hydrolyzable group, a hydroxy group, or a hydrocarbon group,
each of at least four L²s among the L²s is a hydrolyzable group, a group having a hydrolyzable group, or a hydroxy group,
each P is independently an oxygen atom or an organic group having one carbon atom bonded to adjacent Si atoms,
r1 is an integer from 1 to 3, and
*^{S3} is a bonding site to a linking group represented by A in Formula (A).

2. The composition according to claim 1, wherein each of the first compound and the second compound is represented by Formula (1), and T in Formula (1) of the first compound is different from T in Formula (1) of the second compound: 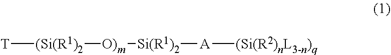
wherein, in Formula (1):
T is a monovalent group,
each R¹ is independently a monovalent hydrocarbon group,
A is a (q+1)-valent linking group,
each R² is independently a monovalent hydrocarbon group,
each L is independently a hydrolyzable group, a group having a hydrolyzable group, or a hydroxy group,
m is a number of 1 or more,
each n is independently an integer from 0 to 2, and
q is an integer of 1 or more.

3. The composition according to claim 1, wherein in Formula (A), T is a methyl group, a linear alkyl group having 2 or more carbon atoms, an alkyl group having 3 or more carbon atoms and having at least one of a branched structure or a cyclic structure, a group represented by Formula (2A), or a group represented by Formula (2B), 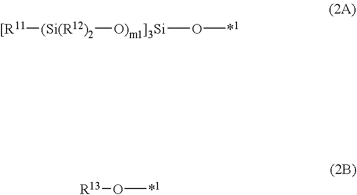
wherein, in Formulae (2A) and (2B):
each R¹¹ is independently a monovalent hydrocarbon group or a group R¹⁴₃Si—O—*², each of two or more of the three R¹¹s is R¹⁴₃Si—O—*², each R¹⁴ is independently a monovalent hydrocarbon group or a trialkylsilyloxy group, and *² is a bonding site to a silicon atom in Formula (2A),
each R¹² is independently a monovalent hydrocarbon group,
each m1 is independently a number of 0 or more,
R¹³ is a monovalent cyclic polysiloxane residue or a monovalent cage-like polysiloxane residue, and
*¹ is a bonding site to a silicon atom in Formula (A).

4. The composition according to claim 3, wherein T in Formula (A) of the second compound is a methyl group, a linear alkyl group having 2 or more carbon atoms, or an alkyl group having 3 or more carbon atoms and having at least one of a branched structure or a cyclic structure.

5. The composition according to claim 4, wherein T in Formula (A) of the first compound is a group represented by Formula (2A) or a group represented by Formula (2B).

6. The composition according to claim 1, wherein Y¹ in Formula (A) of the first compound is different from Y¹ in Formula (A) of the second compound.

7. The composition according to claim 6, wherein:
Y¹ in Formula (A) of the first compound is a group represented by Formula (1A), and
Y¹ in Formula (A) of the second compound is a monovalent hydrocarbon group.

8. The composition according to claim 1, wherein q in Formula (A) is an integer from 1 to 4.

9. The composition according to claim 1, wherein m in Formula (A) is a number from 1 to 500.

10. The composition according to claim 1, further comprising a liquid medium.

11. A surface treatment agent comprising the composition according to claim 1.

12. A method of producing an article, the method comprising subjecting a substrate to a surface treatment using the surface treatment agent according to claim 11 to produce an article having a surface treatment layer formed on the substrate.

13. An article comprising:
a substrate; and
a surface treatment layer disposed on the substrate and formed by a surface treatment using the surface treatment agent according to claim 11.

14. The article according to claim 13, which is an optical member.

15. The article according to claim 13, which is a display or a touch panel.

16. A surface treatment agent comprising the composition according to claim 2.

17. A method of producing an article, the method comprising subjecting a substrate to a surface treatment using the surface treatment agent according to claim 16 to produce an article having a surface treatment layer formed on the substrate.

18. An article comprising:
a substrate; and
a surface treatment layer disposed on the substrate and formed by a surface treatment using the surface treatment agent according to claim 16.

19. The article according to claim 18, which is an optical member.

20. The article according to claim 18, which is a display or a touch panel.
